(19) United States
(12) Patent Application Publication
(10) Pub. No.: US 2026/0126974 A1
(43) Pub. Date: May 7, 2026

(54) APPARATUS, SYSTEM, AND METHOD OF COMPILING CODE FOR A PROCESSOR

(71) Applicant: MobilEye Vision Technologies Ltd., Jerusalem (IL)

(72) Inventors: Michael MARJIEH, Nazareth (IL); Alon KOM, Haifa (IL); Oren BENITA BEN-SIMHON, Haifa (IL)

(73) Assignee: MobilEye Vision Technologies Ltd., Jerusalem (IL)

(21) Appl. No.: 19/119,427

(22) PCT Filed: Oct. 12, 2023
(86) PCT No.: PCT/IB2023/060303

§ 371 Date: Apr. 9, 2025

Related U.S. Application Data
(60) Provisional application No. 63/415,305, filed on Oct. 12, 2022.

(51) Int. Cl. G06F 8/41

(52) U.S. Cl. CPC G06F 8/41

(57) ABSTRACT

For example, a compiler may be configured to identify a first data operation and a second data operation, which are executable in parallel according to a SIMD instruction to be executed by a single ALU of a target processor: to determine a selected compilation scheme from a first compilation scheme and a second compilation scheme based on a predefined selection criterion, wherein the first compilation scheme includes compilation of the first data operation and the second data operation into the SIMD instruction, wherein the second compilation scheme includes compilation of the first data operation into a first ALU instruction, and compilation of the second data operation into a second ALU instruction to be executed separately from the first ALU instruction; and to generate target code based on compilation of the first data operation and the second data operation according to the selected compilation scheme.

### CROSS REFERENCE

This application claims the benefit of and priority from U.S. Provisional Patent Application No. 63/415,305 entitled “APPARATUS, SYSTEM, AND METHOD OF COMPILING CODE FOR A PROCESSOR”, filed Oct. 12, 2022, the entire disclosure of which is incorporated herein by reference.

### BACKGROUND

A compiler may be configured to compile source code into target code configured for execution by a processor.

There is a need to provide a technical solution to support efficient processing functionalities.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of a compiler, in accordance with some demonstrative aspects.

FIG. 3 is a schematic illustration of a vector processor, in accordance with some demonstrative aspects.

FIG. 4 is a schematic flow-chart illustration of a method of compiling code for a processor, in accordance with some demonstrative aspects.

FIG. 5 is a schematic flow-chart illustration of a method of compiling code for a processor, in accordance with some demonstrative aspects.

FIG. 6 is a schematic illustration of a product, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Some portions of the following detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities capture the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Discussions herein utilizing terms such as, for example, “processing”. “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects, for example, may capture the form of an entirely hardware aspect, an entirely software aspect, or an aspect including both hardware and software elements. Some aspects may be implemented in software, which includes but is not limited to firmware, resident software, microcode, or the like.

Furthermore, some aspects may capture the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some demonstrative aspects, the medium may be an electronic, magnetic, optical, electromagnetic, infrared, or semiconductor system (or apparatus or device) or a propagation medium.

In some demonstrative aspects, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some demonstrative aspects, input/output or I/O devices (including but not limited to keyboards, displays, pointing devices, etc.) may be coupled to the system either directly or through intervening I/O controllers. In some demonstrative aspects, network adapters may be coupled to the system to enable the data processing system to become coupled to other data processing systems or remote printers or storage devices, for example, through intervening private or public networks. In some demonstrative aspects, modems, cable modems and Ethernet cards are demonstrative examples of types of network adapters. Other suitable components may be used.

Some aspects may be used in conjunction with various devices and systems, for example, a computing device, a computer, a mobile computer, a non-mobile computer, a server computer, or the like.

As used herein, the term “circuitry” may refer to, be part of, or include, an Application Specific Integrated Circuit (ASIC), an integrated circuit, an electronic circuit, a processor (shared, dedicated or group), and/or memory (shared. Dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g., processor circuitry, control circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

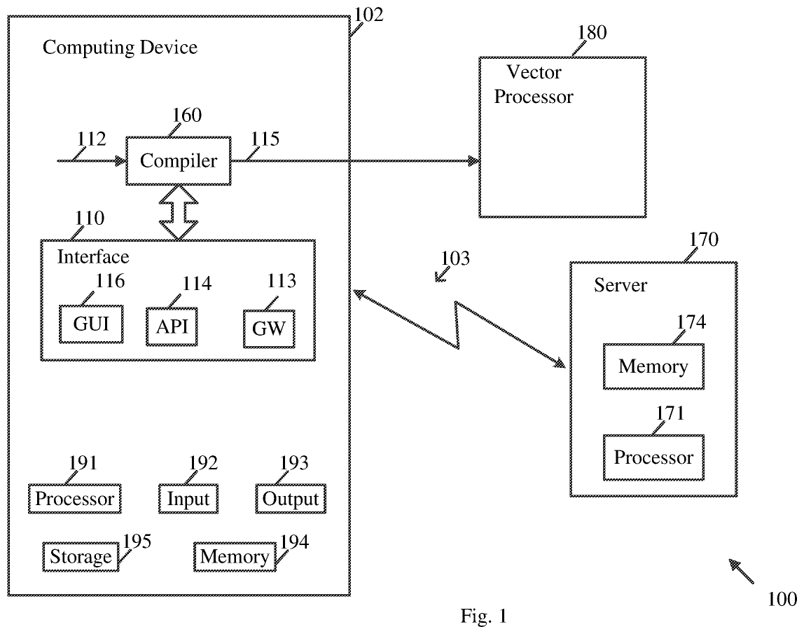

Reference is now made to FIG. 1, which schematically illustrates a block diagram of a system 100, in accordance with some demonstrative aspects.

As shown in FIG. 1, in some demonstrative aspects system 100 may include a computing device 102.

In some demonstrative aspects, device 102 may be implemented using suitable hardware components and/or software components, for example, processors, controllers, memory units, storage units, input units, output units, communication units, operating systems, applications, or the like.

In some demonstrative aspects, device 102 may include, for example, a computer, a mobile computing device, a non-mobile computing device, a laptop computer, a notebook computer, a tablet computer, a handheld computer, a Personal Computer (PC), or the like.

In some demonstrative aspects, device 102 may include, for example, one or more of a processor 191, an input unit 192, an output unit 193, a memory unit 194, and/or a storage unit 195. Device 102 may optionally include other suitable hardware components and/or software components. In some demonstrative aspects, some or all of the components of one or more of device 102 may be enclosed in a common housing or packaging, and may be interconnected or operably associated using one or more wired or wireless links. In other aspects, components of one or more of device 102 may be distributed among multiple or separate devices.

In some demonstrative aspects, processor 191 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications.

In some demonstrative aspects, input unit 192 may include, for example, a keyboard, a keypad, a mouse, a touch-screen, a touch-pad, a track-ball, a stylus, a microphone, or other suitable pointing device or input device. Output unit 193 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 may include, for example, a hard disk drive, a Solid State Drive (SSD), or other suitable removable or non-removable storage units. Memory unit 194 and/or storage unit 195, for example, may store data processed by device 102.

In some demonstrative aspects, device 102 may be configured to communicate with one or more other devices via at least one network 103, e.g., a wireless and/or wired network.

In some demonstrative aspects, network 103 may include a wired network, a local area network (LAN), a wireless network, a wireless LAN (WLAN) network, a radio network, a cellular network, a WiFi network, an IR network, a Bluetooth (BT) network, and the like.

In some demonstrative aspects, device 102 may be configured to perform and/or to execute one or more operations, modules, processes, procedures and/or the like, e.g., as described herein.

In some demonstrative aspects, device 102 may include a compiler 160, which may be configured to generate a target code 115, for example, based on a source code 112, e.g., as described below.

In some demonstrative aspects, compiler 160 may be configured to translate the source code 112 into the target code 115, e.g., as described below.

In some demonstrative aspects, compiler 160 may include, or may be implemented as, software, a software module, an application, a program, a subroutine, instructions, an instruction set, computing code, words, values, symbols, and/or the like.

In some demonstrative aspects, the source code 112 may include computer code written in a source language.

In some demonstrative aspects, the source language may include a programing language. For example, the source language may include a high-level programming language, for example, such as, C language, C++ language, and/or the like.

In some demonstrative aspects, the target code 115 may include computer code written in a target language.

In some demonstrative aspects, the target language may include a low-level language, for example, such as, assembly language, object code, machine code, or the like.

In some demonstrative aspects, the target code 115 may include one or more object files, e.g., which may create and/or form an executable program.

In some demonstrative aspects, the executable program may be configured to be executed on a target computer. For example, the target computer may include a specific computer hardware, a specific machine, and/or a specific operating system.

In some demonstrative aspects, the executable program may be configured to be executed on a processor 180, e.g., as described below.

In some demonstrative aspects, processor 180 may include a vector processor 180, e.g., as described below. In other aspects, processor 180 may include any other type of processor.

Some demonstrative aspects are described herein with respect to a compiler, e.g., compiler 160, configured to compile source code 112 into target code 115 configured to be executed by a vector processor 180, e.g., as described below. In other aspects, a compiler, e.g., compiler 160, configured to compile source code 112 into target code 115 configured to be executed by any other type of processor 180.

In some demonstrative aspects, processor 180 may be implemented as part of device 102.

In other aspects, processor 180 may be implemented as part of any other device, e.g., separate from device 102.

In some demonstrative aspects, vector processor 180 (also referred to as an “array processor”) may include a processor, which may be configured to process an entire vector in one instruction, e.g., as described below.

In other aspects, the executable program may be configured to be executed on any other additional or alternative type of processor.

In some demonstrative aspects, the vector processor 180 may be designed to support high-performance image and/or vector processing. For example, the vector processor 180 may be configured to processes 1/2/3/4D arrays of fixed point data and/or floating point arrays, e.g., very quickly and/or efficiently.

In some demonstrative aspects, the vector processor 180 may be configured to process arbitrary data, e.g., structures with pointers to structures. For example, the vector processor 180 may include a scalar processor to compute the non-vector data, for example, assuming the non-vector data is minimal.

In some demonstrative aspects, compiler 160 may be implemented as a local application to be executed by device 102. For example, memory unit 194 and/or storage unit 195 may store instructions resulting in compiler 160, and/or processor 191 may be configured to execute the instructions resulting in compiler 160 and/or to perform one or more calculations and/or processes of compiler 160, e.g., as described below.

In other aspects, compiler 160 may include a remote application to be executed by any suitable computing system, e.g., a server 170.

In some demonstrative aspects, server 170 may include at least a remote server, a web-based server, a cloud server, and/or any other server.

In some demonstrative aspects, the server 170 may include a suitable memory and/or storage unit 174 having stored thereon instructions resulting in compiler 160, and a suitable processor 171 to execute the instructions, e.g., as descried below.

In some demonstrative aspects, compiler 160 may include a combination of a remote application and a local application.

In one example, compiler 160 may be downloaded and/or received by the user of device 102 from another computing system, e.g., server 170, such that compiler 160 may be executed locally by users of device 102. For example, the instructions may be received and stored, e.g., temporarily, in a memory or any suitable short-term memory or buffer of device 102, e.g., prior to being executed by processor 191 of device 102.

In another example, compiler 160 may include a client-module to be executed locally by device 102, and a server module to be executed by server 170. For example, the client-module may include and/or may be implemented as a local application, a web application, a web site, a web client, e.g., a Hypertext Markup Language (HTML) web application, or the like.

For example, one or more first operations of compiler 160 may be performed locally, for example, by device 102, and/or one or more second operations of compiler 160 may be performed remotely, for example, by server 170.

In other aspects, compiler 160 may include, or may be implemented by, any other suitable computing arrangement and/or scheme.

In some demonstrative aspects, system 100 may include an interface 110, e.g., a user interface, to interface between a user of device 102 and one or more elements of system 100, e.g., compiler 160.

In some demonstrative aspects, interface 110 may be implemented using any suitable hardware components and/or software components, for example, processors, controllers, memory units, storage units, input units, output units, communication units, operating systems, and/or applications.

In some aspects, interface 110 may be implemented as part of any suitable module, system, device, or component of system 100.

In other aspects, interface 110 may be implemented as a separate element of system 100.

In some demonstrative aspects, interface 110 may be implemented as part of device 102. For example, interface 110 may be associated with and/or included as part of device 102.

In one example, interface 110 may be implemented, for example, as middleware, and/or as part of any suitable application of device 102. For example, interface 110 may be implemented as part of compiler 160 and/or as part of an OS of device 102.

In some demonstrative aspects, interface 110 may be implemented as part of server 170. For example, interface 110 may be associated with and/or included as part of server 170.

In one example, interface 110 may include, or may be part of a Web-based application, a web-site, a web-page, a plug-in, an ActiveX control, a rich content component, e.g., a Flash or Shockwave component, or the like.

In some demonstrative aspects, interface 110 may be associated with and/or may include, for example, a gateway (GW) 113 and/or an Application Programming Interface (API) 114, for example, to communicate information and/or communications between elements of system 100 and/or to one or more other, e.g., internal or external, parties, users, applications and/or systems.

In some aspects, interface 110 may include any suitable Graphic-User-Interface (GUI) 116 and/or any other suitable interface.

In some demonstrative aspects, interface 110 may be configured to receive the source code 112, for example, from a user of device 102, e.g., via GUI 116, and/or API 114.

In some demonstrative aspects, interface 110 may be configured to transfer the source code 112, for example, to compiler 160, for example, to generate the target code 115, e.g., as described below.

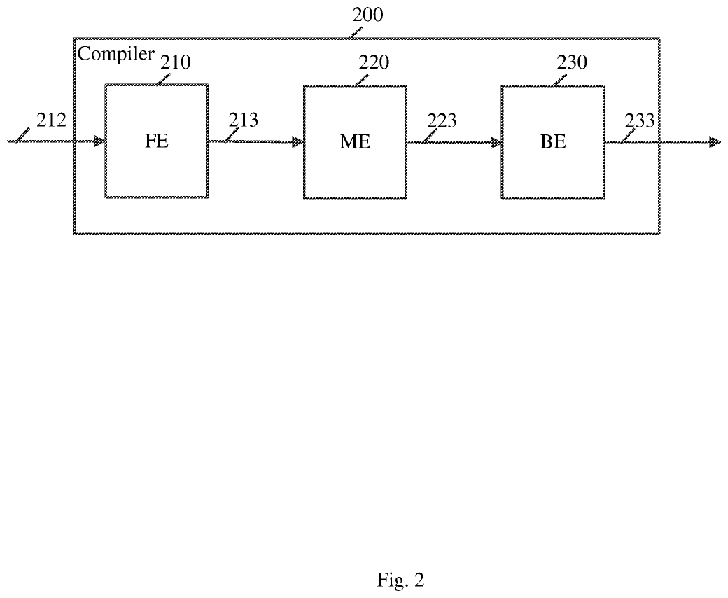

Reference is made to FIG. 2, which schematically illustrates a compiler 200, in accordance with some demonstrative aspects. For example, compiler 160 (FIG. 1) may be implement one or more elements of compiler 200, and/or may perform one or more operations and/or functionalities of compiler 200.

In some demonstrative aspects, as shown in FIG. 2, compiler 200 may be configured to generate a target code 233, for example, by compiling a source code 212 in a source language.

In some demonstrative aspects, as shown in FIG. 2, compiler 200 may include a front-end 210 configured to receive and analyze the source code 212 in the source language.

In some demonstrative aspects, front-end 210 may be configured to generate an intermediate code 213, for example, based on the source code 212.

In some demonstrative aspects, intermediate code 213 may include a lower level representation of the source code 212.

In some demonstrative aspects, front-end 210 may be configured to perform, for example, lexical analysis, syntax analysis, semantic analysis, and/or any other additional or alternative type of analysis, of the source code 212.

In some demonstrative aspects, front-end 210 may be configured to identify errors and/or problems with an outcome of the analysis of the source code 212. For example, front-end 210 may be configured to generate error information, e.g., including error and/or warning messages, for example, which may identify a location in the source code 212, for example, where an error or a problem is detected.

In some demonstrative aspects, as shown in FIG. 2, compiler 200 may include a middle-end 220 configured to receive and process the intermediate code 213, and to generate an adjusted, e.g., optimized, intermediate code 223.

In some demonstrative aspects, middle-end 220 may be configured to perform one or more adjustment, e.g., optimizations, to the intermediate code 213, for example, to generate the adjusted intermediate code 223.

In some demonstrative aspects, middle-end 220 may be configured to perform the one or more optimizations on the intermediate code 213, for example, independent of a type of the target computer to execute the target code 233.

In some demonstrative aspects, middle-end 220 may be implemented to support use of the optimized intermediate code 223, for example, for different machine types.

In some demonstrative aspects, middle-end 220 may be configured to optimize the intermediate representation of the intermediate code 223, for example, to improve performance and/or quality of the produced target code 233.

In some demonstrative aspects, the one or more optimizations of the intermediate code 213, may include, for example, inline expansion, dead-code elimination, constant propagation, loop transformation, parallelization, and/or the like.

In some demonstrative aspects, as shown in FIG. 2, compiler 200 may include a back-end 230 configured to receive and process the adjusted intermediate code 213, and to generate the target code 233 based on the adjusted intermediate code 213.

In some demonstrative aspects, back-end 230 may be configured to perform one or more operations and/or processes, which may be specific for the target computer to execute the target code 233. For example, back-end 230 may be configured to process the optimized intermediate code 213 by applying to the adjusted intermediate code 213 analysis, transformation, and/or optimization operations, which may be configured, for example, based on the target computer to execute the target code 233.

In some demonstrative aspects, the one or more analysis, transformation, and/or optimization operations applied to the adjusted intermediate code 213 may include, for example, resource and storage decisions, e.g., register allocation, instruction scheduling, and/or the like.

In some demonstrative aspects, the target code 233 may include target-dependent assembly code, which may be specific to the target computer and/or a target operating system of the target computer, which is to execute the target code 233.

In some demonstrative aspects, the target code 233 may include target-dependent assembly code for a processor, e.g., vector processor 180 (FIG. 1).

In some demonstrative aspects, compiler 200 may include a Vector Micro-Code Processor (VMP) Open Computing Language (OpenCL) compiler, e.g., as described below. In other aspects, compiler 200 may include, or may be implemented as part of, any other type of vector processor compiler.

In some demonstrative aspects, the VMP OpenCL compiler may include a Low Level Virtual Machine (LLVM) based (LLVM-based) compiler, which may be configured according to an LLVM-based compilation scheme, for example, to lower OpenCL C-code to VMP accelerator assembly code, e.g., suitable for execution by vector processor 180 (FIG. 1).

In some demonstrative aspects, compiler 200 may include one or more technologies, which may be required to compile code to a format suitable for a VMP architecture, e.g., in addition to open-sourced LLVM compiler passes.

In some demonstrative aspects, FE 210 may be configured to parse the OpenCL C-code and to translate it, e.g., through an Abstract Syntax Tree (AST), for example, into an LLVM Intermediate Representation (IR).

In some demonstrative aspects, compiler 200 may include a dedicated API, for example, to detect a correct pattern for compiler pattern matching, for example, suitable for the VMP. For example, the VMP may be configured as a Complex Instruction Set Computer (CISC) machine implementing a very complex Instruction Set Architecture (ISA), which may be hard to target from standard C code. Accordingly, compiler pattern matching may not be able to easily detect the correct pattern, and for this case the compiler may require a dedicated API.

In some demonstrative aspects, FE 210 may implement one or more vendor extension built-ins, which may target VMP-specific ISA, for example, in addition to standard OpenCL built-ins, which may be optimized to a VMP machine.

In some demonstrative aspects, FE 210 may be configured to implement OpenCL structures and/or work item functions.

In some demonstrative aspects, ME 220 may be configured to process LLVM IR code, which may be general and target-independent, for example, although it may include one or more hooks for specific target architectures.

In some demonstrative aspects, ME 220 may perform one or more custom passes, for example, to support the VMP architecture, e.g., as described below.

In some demonstrative aspects, ME 220 may be configured to perform one or more operations of a Control Flow Graph (CFG) Linearization analysis, e.g., as described below.

In some demonstrative aspects, the CFG Linearization analysis may be configured to linearize the code, for example, by converting if-statements to select patterns, for example, in case VMP vector code does not support standard control flow.

In one example, ME 220 may receive a given code, e.g., as follows:

```
If (x > 0) {
  A = A + 5;
} else }
  B = B * 2;
}
```

According to this example, ME 220 may be configured to apply the CFG Linearization analysis to the given code, e.g., as follows:

tmpA = A + 5;
tmpB = B * 2;
mask = x > 0;
A = Select mask, tmpA, A
B = Select not mask, tmpB, B

### Example (1)

In some demonstrative aspects, ME 220 may be configured to perform one or more operations of an auto-vectorization analysis, e.g., as described below.

In some demonstrative aspects, the auto-vectorization analysis may be configured to vectorize, e.g., auto-vectorize, a given code, e.g., to utilize vector capabilities of the VMP.

In some demonstrative aspects, ME 220 may be configured to perform the auto-vectorization analysis, for example, to vectorize code in a scalar form. For example, some or all operations of the auto-vectorization analysis may not be performed, for example, in case the code is already provided in a vectorized form.

In some demonstrative aspects, for example, in some use cases and/or scenarios, a compiler may not always be able to auto-vectorize a code, for example, due to data dependencies between loop iterations.

In one example, ME 220 may receive a given code, e.g., as follows:

char* a,b,c;
for (int i=0; i < 2048; i++) {
a[i]=b[i]+c[i];
}

According to this example, ME 220 may be configured to perform the CFG auto-vectorization analysis by applying a first conversion, e.g., as follows:

char* a,b,c;
for (int i=0; i < 2048; i+=32) {
a[i.i+31]=b[i...i+31]+c[i...i+31];
}

### Example (2a)

For example, ME 220 may be configured to perform the CFG auto-vectorization analysis by applying a second conversion, for example, following the first conversion, e.g., as follows:

char32* a,b,c;
for (int i=0; i < 64; i++) {
a[i]=b[i]+c[i];
}

### Example (2b)

In some demonstrative aspects, ME 220 may be configured to perform one or more operations of a Scratch Pad Memory Loop Access Analysis (SPMLAA), e.g., as described below.

In some demonstrative aspects, the SPMLAA may define Processing Blocks (PB), e.g., that should be outlined and compiled for VMP later.

In some demonstrative aspects, the processing blocks may include accelerated loops, which may be executed by the vector unit of the VMP.

In some demonstrative aspects, a PB, e.g., each PB, may include memory references. For example, some or all memory accesses may refer to local memory banks.

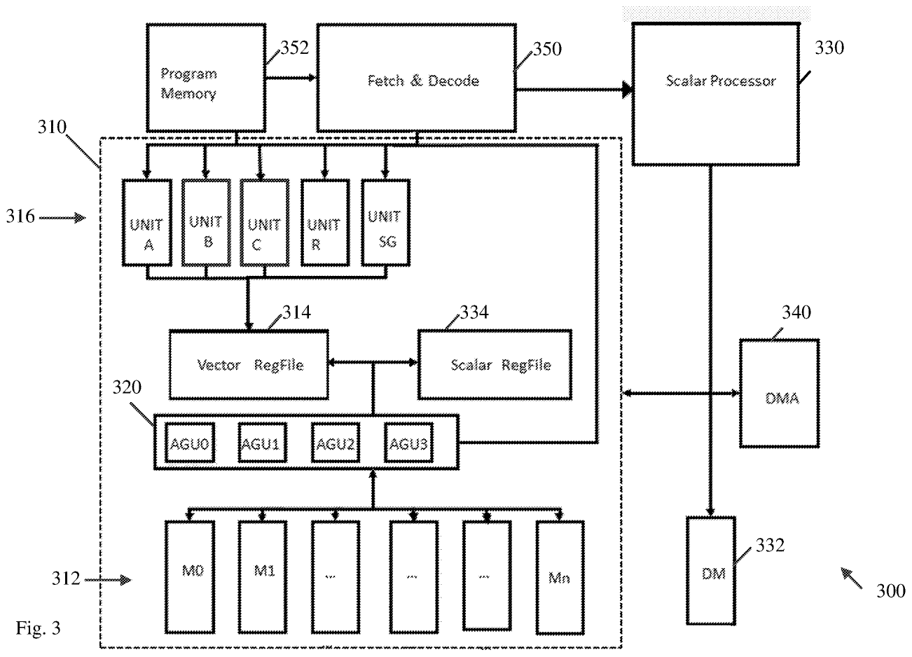

In some demonstrative aspects, the VMP may enable access to memory banks through AGUs, e.g., AGUs 320 as described below with reference to FIG. 3, and Scatter Gather units (SG).

In some demonstrative aspects, the AGUs may be pre-configured, e.g., before loop execution. For example, a loop trip count may be calculated, e.g., ahead of running a processing block.

In some demonstrative aspects, image references, e.g., some or all image references, may be created at this stage, and may be followed by calculation of strides and offsets, e.g., per dimension for each reference.

In some demonstrative aspects, ME 220 may be configured to perform one or more operations of an AGU planner analysis, e.g., as described below.

In some demonstrative aspects, the AGU Planner analysis may include iterator assignment, which may cover image references, e.g., all image references, from the entire Processing Block.

In some demonstrative aspects, an iterator may cover a single reference or a group of references.

In some demonstrative aspects, one or more memory references may be coalesced and/or reuse a same access through shuffle instructions, and/or saving values read from previous iterations.

In some demonstrative aspects, other memory references, e.g., which have no linear access pattern, may be handled using a Scatter-Gather (SG) unit, which may have a performance penalty, e.g., as it may require maintaining indices and/or masks.

In some demonstrative aspects, a plan may be configured as an arrangement of iterators in a processing block. For example, a processing block may have multiple plans, e.g., theoretically.

In some demonstrative aspects, the AGU Planner analysis may be configured to build all possible plans for all PBs, and to select a combination, e.g., a best combination, e.g., from all valid combinations.

In some demonstrative aspects, a total number of iterators in a valid combination may be limited, e.g., not to exceed a number of available AGUs on a VMP.

In some demonstrative aspects, one or more parameters, e.g., including stride, width and/or base, may be defined for an iterator, e.g., for each iterator for example, as part of the AGU Planner analysis. For example, min-max ranges for the iterators may be defined in a dimension, e.g., in each dimension, for example, as part of the AGU Planner analysis.

In some demonstrative aspects, the AGU Planner analysis may be configured to track and evaluate a memory reference, e.g., each memory reference, to an image, e.g., to understand its access pattern.

In one example, according to Examples 2a/2b, the image ‘a’ which is the base address, may be accessed with steps of 32 bytes for 64 iterations.

In some demonstrative aspects, the LLVM may include a scalar evaluation analysis (SCEV), which may compute an access pattern, e.g., to understand every image reference.

In some demonstrative aspects, ME 220 may utilize masking capabilities of the AGUs, for example, to avoid maintaining an induction variable, which may have a performance penalty.

In some demonstrative aspects, ME 220 may be configured to perform one or more operations of a rewrite analysis, e.g., as described below.

In some demonstrative aspects, the rewrite analysis may be configured to transform the code of a processing block, for example, while setting iterators and/or modifying memory access instructions.

In some demonstrative aspects, setting of the iterators, e.g., of all iterators, may be implemented in IR in target-specific intrinsics. For example, the setting of the iterators may reside in a pre-header of an outermost loop.

In some demonstrative aspects, the rewrite analysis may include loop-perfectization analysis, e.g., as described below.

In some demonstrative aspects, the code may be compiled with a target that substantially all calculations should be executed inside the innermost loop.

For example, the loop-perfectization analysis may hoist instructions, e.g., to move into a loop an operation performed after a last iteration of the loop.

For example, the loop-perfectization analysis may sink instructions, e.g., to move into a loop an operation performed before a first iteration of the loop.

For example, the loop-perfectization analysis may hoist instructions and/or sink instructions, for example, such that substantially all instructions are moved from outer loops to the innermost loops.

For example, the loop-perfectization analysis may be configured to provide a technical solution to support VMP iterators, e.g., to work on perfectly nested loops only.

For example, the loop-perfectization analysis may result in a situation where there are no instructions between the “for” statements that compose the loop, e.g., to support VMP iterators, which cannot emulate such cases.

In some demonstrative aspects, the loop-perfectization analysis may be configured to collapse a nested loop into a single collapsed loop.

In one example, ME 220 may receive a given code, e.g., as follows:

```
for (int i = 0; i < N; i++) {
  int sum = 0;
  for (int j = 0; j < M; j++)
  {
    sum += a[j + stride * i];
  }
      res[i] = sum;
}
```

According to this example, ME 220 may be configured to perform the loop-perfectization analysis to collapse the nested loop in the code to a single collapsed loop, e.g., as follows:

```
for (int k = 0; k < N * M; k++) {
  sum = (k % M == 0 ? 0 : sum);
  sum += a[k % M + stride * ( k / M )];
    res[k/M] = sum;
}
```

### Example (3)

In some demonstrative aspects, ME 220 may be configured to perform one or more operations of a Vector Loop Outlining analysis, e.g., as described below.

In some demonstrative aspects, the Vector Loop Outlining analysis may be configured to divide a code between a scalar subsystem and a vector subsystem, e.g., vector processing block 310 (FIG. 3) and scalar processor 330 (FIG. 3) as described below with reference to FIG. 3.

In some demonstrative aspects, the VMP accelerator may include the scalar and/or vector subsystems, e.g., as described below. For example, each of the subsystems may have different compute units/processors. Accordingly, a scalar code may be compiled on a scalar compiler, e.g., an SSC compiler, and/or an accelerated vector code may run on the VMP vector processor.

In some demonstrative aspects, the Vector Loop Outlining analysis may be configured to create a separate function for a loop body of the accelerated vector code. For example, these functions may be marked for the VMP and/or may continue to the VMP backend, for example, while the rest of the code may be compiled by the SSC compiler.

In some demonstrative aspects, one or more parts of a vector loop, e.g., configuration of the vector unit and/or initialization of vector registers, may be performed by a scalar unit. However, these parts may be performed in a later stage, for example, by performing backpatching into the scalar code, e.g., as the scalar code may still be in LLVM IR before processing by the SSC compiler.

In some demonstrative aspects, BE 230 may be configured to translate the LLVM IR into machine instructions. For example, the BE 230 may not be target agnostic and may be familiar with target-specific architecture and optimizations, e.g., compared to ME 220, which may be agnostic to a target-specific architecture.

In some demonstrative aspects, BE 230 may be configured to perform one or more analyses, which may be specific to a target machine, e.g., a VMP machine, to which the code is lowered, e.g., although BE 230 may use common LLVM.

In some demonstrative aspects, BE 230 may be configured to perform one or more operations of an instruction lowering analysis, e.g., as described below.

In some demonstrative aspects, the instruction lowering analysis may be configured to translate LLVM IR into target-specific instructions Machine IR (MIR), for example, by translating the LLVM IR into a Directed Acyclic Graph (DAG).

In some demonstrative aspects, the DAG may go through a legalization process of instructions, for example, based on the data types and/or VMP instructions, which may be supported by a VMP HW.

In some demonstrative aspects, the instruction lowering analysis may be configured to perform a process of pattern-matching, e.g., after the legalization process of instructions, for example, to lower a node, e.g., each node, in the DAG, for example, into a VMP-specific machine instruction.

In some demonstrative aspects, the instruction lowering analysis may be configured to generate the MIR, for example, after the process of pattern-matching.

In some demonstrative aspects, the instruction lowering analysis may be configured to lower the instruction according to machine Application Binary Interface (ABI) and/or calling conventions.

In some demonstrative aspects, BE 230 may be configured to perform one or more operations of a unit balancing analysis, e.g., as described below.

In some demonstrative aspects, the unit balancing analysis may be configured to balance instructions between VMP compute units, e.g., data processing units 316 (FIG. 3) as described below with reference to FIG. 3.

In some demonstrative aspects, the unit balancing analysis may be familiar with some or all available arithmetic transformations, and/or may perform transformations according to an optimal algorithm.

In some demonstrative aspects, BE 230 may be configured to perform one or more operations of a modulo scheduler (pipeliner) analysis, e.g., as described below.

In some demonstrative aspects, the pipeliner may be configured to schedule the instructions according to one or more constraints, e.g., data dependency, resource bottlenecks and/or any other constrains, for example, using Swing Modulo Scheduling (SMS) heuristics and/or any other additional and/or alternative heuristic.

In some demonstrative aspects, the pipeliner may be configured to schedule a set, e.g., an Initiation Interval (II), of Very Long Instruction Word (VLIW) instructions that the program will iterate on, e.g., during a steady state.

In some demonstrative aspects, a performance metric, which may be based on a number of cycles a typical loop may execute, may be measured, e.g., as follows:

(Size of Input data in bytes)*II/(Bytes consumed/produced every iteration)

In some demonstrative aspects, the pipeliner may try to minimize the II, e.g., as much as possible, for example, to improve performance.

In some demonstrative aspects, the pipeliner may be configured to calculate a minimum II, and to schedule accordingly. For example, if the pipeliner fails the scheduling, the pipeliner may try to increase the II and retry scheduling, e.g., until a predefined II threshold is violated.

In some demonstrative aspects, BE 230 may be configured to perform one or more operations of a register allocation analysis, e.g., as described below.

In some demonstrative aspects, the register allocation analysis may be configured to attempt to assign a register in an efficient, e.g., optimal, way.

In some demonstrative aspects, the register allocation analysis may assign values to bypass vector registers, general purpose vector registers, and/or scalar registers.

In some demonstrative aspects, the values may include private variables, constants, and/or values that are rotated across iterations.

In some demonstrative aspects, the register allocation analysis may implement an optimal heuristic that suites one or more VMP register file (regfile) constraints. For example, in some use cases, the register allocation analysis may not use a standard LLVM register allocation.

In some demonstrative aspects, in some cases, the register allocation analysis may fail, which may mean that the loop cannot be compiled. Accordingly, the register allocation analysis may implement a retry mechanism, which may go back to the modulo scheduler and may attempt to reschedule the loop, e.g., with an increased initiation interval. For example, increasing the initiation interval may reduce register pressure, and/or may support compilation of the vector loop, e.g., in many cases.

In some demonstrative aspects, BE 230 may be configured to perform one or more operations of an SSC configuration analysis, e.g., as described below.

In some demonstrative aspects, the SSC configuration analysis may be configured to set a configuration to execute the kernel, e.g., the AGU configuration.

In some demonstrative aspects, the SSC configuration analysis may be performed at a late stage, for example, due to configurations calculated after legalization, the register allocation analysis, and/or the modulo scheduling analysis.

In some demonstrative aspects, the SSC configuration analysis may include a Zero Overhead Loop (ZOL) mechanism in the vector loop. For example, the ZOL mechanism may configure a loop trip count based on an access pattern of the memory references in the loop, for example, to avoid running instructions that check the loop exit condition every iteration.

In some demonstrative aspects, a VMP Compilation Flow may include one or more, e.g., a few, steps, which may be invoked during the compilation flow in a test library (testlib), e.g., a wrapper script for compilation, execution, and/or program testing. For example, these steps may be performed outside of the LLVM Compiler.

In some demonstrative aspects, a PCB Hardware Description Language (PHDL) simulator may be implemented to perform one or more roles of an assembler, encoder, and/or linker.

In some demonstrative aspects, compiler 200 may be configured to provide a technical solution to support robustness, which may enable compilation of a vast selection of loops, with HW limitations. For example, compiler 200 may be configured to support a technical solution, which may not create verification errors.

In some demonstrative aspects, compiler 200 may be configured to provide a technical solution to support programmability, which may provide a user an ability to express code in multiple ways, which may compile correctly to the VMP architecture.

In some demonstrative aspects, compiler 200 may be configured to provide a technical solution to support an improved user-experience, which may allow the user capability to debug and/or profile code. For example, the improved user-experience may provide informative error messages, report tools, and/or a profiler.

In some demonstrative aspects, compiler 200 may be configured to provide a technical solution to support improved performance, for example, to optimize a VMP assembly code and/or iterator accesses, which may lead to a faster execution. For example, improved performance may be achieved through high utilization of the compute units and usage of its complex CISC.

Reference is made to FIG. 3, which schematically illustrates a vector processor 300, in accordance with some demonstrative aspects. For example, vector processor 180 (FIG. 1) may be implement one or more elements of vector processor 300, and/or may perform one or more operations and/or functionalities of vector processor 300.

In some demonstrative aspects, vector processor 300 may include a Vector Microcode Processor (VMP).

In some demonstrative aspects, vector processor 300 may include a Wide Vector machine, for example, supporting Very Long Instruction Word (VLIW) architectures, and/or Single Instruction/Multiple Data (SIMD) architectures.

In some demonstrative aspects, vector processor 300 may be configured to provide a technical solution to support high performance for short integral types, which may be common, for example, in computer-vision and/or deep-learning algorithms.

In other aspects, vector processor 300 may include any other type of vector processor, and/or may be configured to support any other additional or alternative functionalities.

In some demonstrative aspects, as shown in FIG. 3, vector processor 300 may include a vector processing block (vector processor) 310, a scalar processor 330, and a Direct Memory Access (DMA) 340, e.g., as described below.

In some demonstrative aspects, as shown in FIG. 3, vector processing block 310 may be configured to process, e.g., efficiently process, image data and/or vector data. For example, the vector processing block 310 may be configured to use vector computation units, for example, to speed up computations.

In some demonstrative aspects, scalar processor 330 may be configured to perform scalar computations. For example, the scalar processor 330 may be used as a “glue logic” for programs including vector computations. For example, some, e.g., even most, of the computation of the programs may be performed by the vector processing block 310. However, several tasks, for example, some essential tasks, e.g., scalar computations, may be performed by the scalar processor 330.

In some demonstrative aspects, the DMA 340 may be configured to interface with one or more memory elements in a chip including vector processor 300.

In some demonstrative aspects, the DMA 340 may be configured to read inputs from a main memory, and/or write outputs to the main memory.

In some demonstrative aspects, the scalar processor 330 and the vector processing block 310 may use respective local memories to process data.

In some demonstrative aspects, as shown in FIG. 3, vector processor 300 may include a fetcher and decoder 350, which may be configured to control the scalar processor 330 and/or the vector processing block 310.

In some demonstrative aspects, operations of the scalar processor 330 and/or the vector processing block 310 may be triggered by instructions stored in a program memory 352.

In some demonstrative aspects, the DMA 340 may be configured to transfer data, for example, in parallel with the execution of the program instructions in memory 352.

In some demonstrative aspects, DMA 340 may be controlled by software, e.g., via configuration registers, for example, rather than instructions, and, accordingly, may be considered as a second “thread” of execution in vector processor 300.

In some demonstrative aspects, the scalar processor 330, the vector processing block 310, and/or the DMA 340 may include one or more data processing units, for example, a set of data processing units, e.g., as described below.

In some demonstrative aspects, the data processing units may include hardware configured to preform computations, e.g., an Arithmetic Logic Unit (ALU).

In one example, a data processing unit may be configured to add numbers, and/or to store the numbers in a memory.

In some demonstrative aspects, the data processing units may be controlled by commands, e.g., encoded in the program memory 352 and/or in configuration registers. For example, the configuration registers may be memory mapped, and may be written by the memory store commands of the scalar processor 330.

In some demonstrative aspects, the scalar processor 330, the vector processing block 310, and/or the DMA 340 may include a state configuration including a set of registers and memories, e.g., as described below.

In some demonstrative aspects, as shown in FIG. 3, vector processor block 310 may include a set of vector memories 312, which may be configured, for example, to store data to be processed by vector processor block 310.

In some demonstrative aspects, as shown in FIG. 3, vector processor block 310 may include a set of vector registers 314, which may be configured, for example, to be used in data processing by vector processor block 310.

In some demonstrative aspects, the scalar processor 330, the vector processing block 310, and/or the DMA 340 may be associated with a set of memory maps.

In some demonstrative aspects, a memory map may include a set of addresses accessible by a data processing unit, which may load and/or store data from/to registers and memories.

In some demonstrative aspects, as shown in FIG. 3, the vector processing block 310 may include a plurality of Address Generation Units (AGUs) 320, which may include addresses accessible to them, e.g., in one or more of memories 312.

In some demonstrative aspects, as shown in FIG. 3, vector processor block 310 may include a plurality of data processing units 316, e.g., as described below.

In some demonstrative aspects, data processing units 316 may be configured to process commands, e.g., including several numbers at a time. In one example, a command may include 8 numbers. In another example, a command may include 4 numbers, 16 numbers, or any other count of numbers.

In some demonstrative aspects, two or more data processing units 316 may be used simultaneously. In one example, data processing units 316 may process and execute a plurality of different command, e.g., 3 different commands, for example, including 8 numbers, at a throughout of a single cycle.

In some demonstrative aspects, data processing units 316 may be asymmetrical. For example, first and second data processing units 316 may support different commands. For example, addition may be performed by a first data processing unit 316, and/or multiplication may be performed by a second data processing unit 316. For example, both operations may be performed by one or more additional other data processing units 316.

In some demonstrative aspects, data processing units 316 may be configured to support arithmetic operations for many combinations of input & output data types.

In some demonstrative aspects, data processing units 316 may be configured to support one or more operations, which may be less common. For example, processing units 316 may support operations working with a Look Up Table (LUT) of vector processor 300, and/or any other operations.

In some demonstrative aspects, data processing units 316 may be configured to support efficient computation of non-linear functions, histograms, and/or random data access, e.g., which may be useful to implement algorithms like image scaling, Hough transforms, and/or any other algorithms.

In some demonstrative aspects, vector memories 312 may include, for example, memory banks having a size of 16K or any other size, which may be accessed at a same cycle.

In one example, a maximal memory access size may be 64 bits. According to this example, a peak throughput may be 256 bits, e.g., 64×4=256. For example, high memory bandwidth may be implemented to utilize computation capabilities of the data processing units 316.

In one example, two data processing units 316 may support 16 8-bit multiply & accumulate operations (MACs) per cycle. According to this example, the two data processing units 316 may not be useful, for example, in case the input numbers are not fetched at this speed, and/or there isn't exactly 256 bits of input, e.g., 16×8×2=256.

In some demonstrative aspects, AGUs 320 may be configured to perform memory access operations, e.g., loading and storing data from/to vector memories 314.

In some demonstrative aspects, AGUs 320 may be configured to compute addresses of input and output data items, for example, to handle I/O to utilize the data processing units 316, e.g., in case sheer bandwidth is not enough.

In some demonstrative aspects, AGUs 320 may be configured to compute the addresses of the input and/or output data items, for example, based on configuration registers written by the scalar processor 330, for example, before a block of vector commands, e.g., a loop, is entered.

For example, AGUs 320 may be configured to write an image base pointer, a width, a height and/or a stride to the configuration registers, for example, in order to iterate over an image.

In some demonstrative aspects, AGUs 320 may be configured to handle addressing, e.g., all addressing, for example, to provide a technical solution in which data processing units 316 may not have the burden of incrementing pointers or counters in a loop, and/or the burden to check for end-of-row conditions, e.g., to zero a counter in the loop.

In some demonstrative aspects, as shown in FIG. 3, AGUs 320 may include 4 AGUs, and, accordingly, four memories 312 may be accessed at a same cycle. In other aspects, any other count of AGUs 32 may be implemented.

In some demonstrative aspects, AGUs 320 may not be “tied” to memory banks 312. For example, an AGU 320, e.g., each AGU 320, may access a memory bank 312, e.g., every memory bank 312, for example, as long as two or more AGUs 320 do not try to access the same memory bank 312 at the same cycle.

In some demonstrative aspects, vector registers 314 may be configured to support communication between the data processing units 316 and AGUs 320.

In one example, a total number of vector registers 314 may be 28, which may be divided into several subsets, e.g., based on their function. For example, a first subset of vector registers 314 may be used for inputs/outputs, e.g., of all data processing units 316 and/or AGUs 320; and/or a second subset of vector registers 314 may not be used for outputs of some operations, e.g., most operations, and may be used for one or more other operations, e.g., to store loop-invariant inputs.

In some demonstrative aspects, a data processing unit 316, e.g., each data processing unit 316, may have one or more registers to host an output of a last executed operation, e.g., which may be fed as inputs to other data processing units 316. For example, these registers may “bypass” the vector registers 314, and may work faster than writing these outputs to first set of vector registers 314.

In some demonstrative aspects, fetcher and decoder 350 may be configured to support low-overhead vector loops, e.g., very low overhead vector loops (also referred to as “zero-overhead vector loops”), for example, where there may be no need to check a termination (exit) condition of a vector loop during an execution of the vector loop.

For example, a termination (exit) condition may be signaled by an AGU 320, for example, when the AGU 320 finishes iterating over a configured memory region.

For example, fetcher and decoder 350 may quit the loop, for example, when the AGU 320 signals the termination condition.

For example, the scalar processor 330 may be utilized to configure the loop parameters, e.g., first & last instructions and/or the exit condition.

In one example, vector loops may be utilized, for example, together with high memory bandwidth and/or cheap addressing, for example, to solve a control and data flow problem, for example, to provide a technical solution to allow the data processing units 316 to process data, e.g., without substantially additional overhead.

In some demonstrative aspects, scalar processor 330 may be configured to provide one or more functionalities, which may be complementary to those of the vector processing block 310. For example, a large portion, e.g., most, of the work in a vector program may be performed by the data processing units 316. For example, the scalar processor 330 may be utilized, for example, for “gluing” together the various blocks of vector code of the vector program.

In some demonstrative aspects, scalar processor 330 may be implemented separately from vector processing block 310. In other aspects, scalar processor 330 may be configured to share one or more components and/or functionalities with vector processing block 310.

In some demonstrative aspects, scalar processor 330 may be configured to perform operations, which may not be suitable for execution on vector processing block 310.

For example, scalar processor 330 may be utilized to execute 32 bit C programs. For example, scalar processor 330 may be configured to support 1, 2, and/or 4 byte data types of C code, and/or some or all arithmetic operators of C code.

For example, scalar processor 330 may be configured to provide a technical solution to perform operations that cannot be executed on vector processing block 310, for example, without using a full-blown CPU.

In some demonstrative aspects, scalar processor 330 may include a scalar data memory 332, e.g., having a size of 16K or any other size, which may be configured to store data, e.g., variables used by the scalar parts of a program.

For example, scalar processor 330 may store local and/or global variables declared by portable C code, which may be allocated to scalar data memory by a compiler, e.g., compiler 200 (FIG. 2).

In some demonstrative aspects, as shown in FIG. 3, scalar processor 330 may include, or may be associated with, a set of vector registers 334, which may be used in data processing performed by the scalar processor 330.

In some demonstrative aspects, scalar processor 330 may be associated with a scalar memory map, which may support scalar processor 330 in accessing substantially all states of vector processor 300. For example, the scalar processor 330 may configure the vector units and/or the DMA channels via the scalar memory map.

In some demonstrative aspects, scalar processor 330 may not be allowed to access one or more block control registers, which may be used by external processors to run and debug vector programs.

In some demonstrative aspects, DMA 340 may be configured to communicate with one or more other components of a chip implementing the vector processor 300, for example, via main memory. For example, DMA 340 may be configured to transfer blocks of data, e.g., large, contiguous, blocks of data, for example, to support the scalar processor 330 and/or the vector processing block, which may manipulate data stored in the local memories. For example, a vector program may be able to read data from the main chip memory using DMA 340.

In some demonstrative aspects, DMA 340 may be configured to communicate with other elements of the chip, for example, via a plurality of DMA channels, e.g., 8 DMA channels or any other count of DMA channels. For example, a DMA channel, e.g., each DMA channel, may be capable of transferring a rectangular patch from the local memories to the main chip memory, or vice versa. In other aspects, the DMA channel may transfer any other type of data block between the local memories and the main chip memory.

In some demonstrative aspects, a rectangular patch may be defined by a base pointer, a width, a height, and astride.

For example, at peak throughput, 8 bytes per cycle may be transferred, however, there may be overheads for each patch and/or for each row in a patch.

In some demonstrative aspects, DMA 340 may be configured to transfer data, for example, in parallel with computations, e.g., via the plurality of DMA channels, for example, as long as executed commands do not access a local memory involved in the transfer.

In one example, as all channels may access the same memory bus, using several channels to implement a transfer may not save I/O cycles, e.g., compared to the case when a single channel is used. However, the plurality of DMA channels may be utilized to schedule several transfers and execute them in parallel with computations. This may be advantageous, for example, compared to a single channel, which may not allow scheduling a second transfer before completion of the first transfer.

In some demonstrative aspects, DMA 340 may be associated with a memory map, which may support the DMA channels in accessing vector memories and/or the scalar data. For example, access to the vector memories may be performed in parallel with computations. For example, access to the scalar data may usually not be allowed in parallel, e.g., as the scalar processor 330 may be involved in almost any sensible program, and may likely access it's local variables while the transfer is performed, which may lead to a memory contention with the active DMA channel.

In some demonstrative aspects, DMA 340 may be configured to provide a technical solution to support parallelization of I/O and computations. For example, a program performing computations may not have to wait for I/O, for example, in case these computations may run fast by vector processing block 310.

In some demonstrative aspects, an external processor, e.g., a CPU, may be configured to initiate execution of a program on vector processor 300. For example, vector processor 300 may remain idle, e.g., as long as program execution is not initiated.

In some demonstrative aspects, the external processor may be configured to debug the program, e.g., execute a single step at a time, halt when the program reaches breakpoints, and/or inspect contents of registers and memories storing the program variables.

In some demonstrative aspects, an external memory map may be implemented to support the external processor in controlling the vector processor 300 and/or debugging the program, for example, by writing to control registers of the vector processor 300.

In some demonstrative aspects, the external memory map may be implemented by a superset of the scalar memory map. For example, this implementation may make all registers and memories defined by the architecture of the vector processor 300 accessible to a debugger back-end running on the external processor.

In some demonstrative aspects, the vector processor 300 may raise an interrupt signal, for example, when the vector processor 300 terminates a program.

In some demonstrative aspects, the interrupt signal may be used, for example to implement a driver to maintain a queue of programs scheduled for execution by the vector processor 300, and/or to launch a new program, e.g., by the external processor, for example, upon the completion of a previously executed program.

Referring back to FIG. 1, in some demonstrative aspects, compiler 160 may be configured to generate the target code 115 configured, for example, to utilize registers of a processor, for example, a vector processor, e.g., vector processor 180, according to a register allocation scheme, e.g., as described below.

In some demonstrative aspects, the register allocation scheme may be configured to provide a technical solution to reduce a usage of allocated registers for executing a program by a processor, for example, a vector processor, e.g., as described below.

In some demonstrative aspects, the register allocation scheme may be configured to provide a technical solution to utilize a reduced, e.g., optimized and/or minimal, number of allocated registers for executing a program by a processor, for example, a vector processor, e.g., as described below.

In one example, the register allocation scheme may be configured to provide a technical solution to utilize a reduced, e.g., optimized and/or minimal, number of allocated registers, which may be allocated from the plurality of vector registers 314 (FIG. 3), for execution of a program by vector processor 300 (FIG. 3), e.g., as described below.

In some demonstrative aspects, a compiler, e.g., compiler 160, may be configured to generate target code, e.g., the target code 115, which may be configured to utilize registers of a vector processor, e.g., vector processor 180, according to a register allocation scheme, e.g., as described below.

In other aspects, a compiler, e.g., compiler 160, may be configured to generate target code, e.g., the target code 115, which may be configured to utilize registers of any other suitable type of processor according to the register allocation scheme, e.g., as described below.

In some demonstrative aspects, the register allocation scheme may be configured to provide a technical solution improve, e.g., to optimize, an allocation of registers to execute the executable program, e.g., as described below.

In some demonstrative aspects, the register allocation scheme may be configured to provide a technical solution to support an improved allocation, for example, an efficient allocation, e.g., an optimized allocation, of registers to execute the executable program, e.g., as described below.

In some demonstrative aspects, the register allocation scheme may be configured to provide a technical solution to utilize a reduced number, for example, an optimized number, e.g., a minimal number, of allocated registers to execute the executable program, e.g., as described below.

In some demonstrative aspects, the register allocation scheme may be configured to provide a technical solution to improve performance of the executable program, for example, by reducing the number of allocated registers to execute the executable program, e.g., as described below.

In some demonstrative aspects, the register allocation scheme may be configured to provide a technical solution to reduce the usage of the allocated registers, for example, by reducing ranges of live intervals of one or more variables, e.g., as described below.

In some demonstrative aspects, a live range of a variable may include a range of cycles of the executable program, for example, between a first cycle, e.g., which includes a first use and/or a production of the variable, and a second cycle, e.g., which includes a second use, e.g., subsequent to the first use, of the variable, e.g., as described below.

In some demonstrative aspects, there may be a need to provide a technical solution to efficiently allocate registers of a processor, e.g., a vector processor, for execution of a program, for example, in order to reduce a usage of the allocated registers, for example, allocated vector registers, e.g., as described below.

For example, a number of physical registers implemented by a chip including a processor, e.g., a vector processor or any other processor, may be limited, for example, according to a design and/or layout of the chip. For example, a number of vector registers implemented by the vector processor may be limited by the number of physical registers on the chip implementing the vector processor.

In some demonstrative aspects, the register allocation scheme may be configured to provide a technical solution to reduce, e.g., optimize and/or minimize, the number of the allocated registers, for example, for CPUs, e.g., vector processors, having limited storage capabilities, e.g., a limited register pool.

In some demonstrative aspects, the register allocation scheme may be configured to provide a technical solution to reduce, e.g., optimize and/or minimize, the number of the allocated registers, for example, for CPUs, e.g., vector processors, having limited support of, or not having support of, memory spill/fill operations, e.g., to store live values.

For example, processors having no fill/spill capabilities and/or limited storage capabilities may be forced to use compute resources instead.

In one example, a processor may identify an unsuccessful register allocation according to an instruction scheduling, e.g., due to a limited number of registers, which may not be able to support the register allocation according to the instruction scheduling. One option to address this situation may be to relax the instruction scheduling, e.g., in attempt to reduce the number of live variables sharing the same execution cycles. However, this option may result in degraded performance.

In some demonstrative aspects, the register allocation scheme may be configured to provide a technical solution to reduce the number of the allocated registers, for example, to avoid, or even eliminate, the use of these extra compute resources.

In some demonstrative aspects, the register allocation scheme may be configured to provide a technical solution to reduce a register pressure for execution of a program by a processor, for example, a vector processor, and/or any other processor.

In some demonstrative aspects, the register allocation scheme may be configured to provide a technical solution to reduce the register pressure, for example, by reducing the number of allocated registers for execution of the program, e.g., as described below.

In some demonstrative aspects, the register allocation scheme may be configured to provide a technical solution to support efficient execution of programs, e.g., complex programs, which may be sensitive to register pressure. For example, for some programs, a register pressure issue may be a bottleneck, and, accordingly, the register pressure may affect performance.

In some demonstrative aspects, the register allocation scheme may be configured to provide a technical solution to reduce, e.g., optimize and/or minimize, the number of allocated registers for execution of a program, for example, while providing a suitable allocation of registers, e.g., vector registers, for execution of the program, e.g., as described below.

In some demonstrative aspects, the register allocation scheme may be configured to provide a technical solution to reduce, e.g., minimize and/or optimize, ranges of live intervals for one or more variables, e.g., as described below.

In some demonstrative aspects, the reduction of the ranges of live intervals may provide a technical solution to support reduced register usage and, accordingly, to support reduction, e.g., minimization and/or optimization, of register pressure.

For example, the register allocation scheme may be implemented to provide a technical solution to support efficient execution of programs, which may be subject to a register pressure problem.

In some demonstrative aspects, the register allocation scheme may be configured to provide a technical solution to support improved performance of programs, which may be executed, for example, by exposed pipeline processors, and/or any other additional or alternative type of processors.

In some demonstrative aspects, complier 160 may be configured to process a given instruction scheduling, e.g., based on the source code 112, and to generate target code 115, which may be configured to utilize a reduced, e.g., optimized and/or minimized, number of allocated registers, for example, for a successful register allocation, e.g., as described below.

In some demonstrative aspects, complier 160 may be configured to identify in the given instruction scheduling a pair of instructions, e.g., including a first instruction and a second instruction, which may be independent and/or similar.

In some demonstrative aspects, compiler 160 may be configured to determine whether to perform the first instruction and the second instruction in parallel, e.g., using a single SIMD instruction, or to perform the first instruction and the second instruction using two separate instructions, e.g., as descried below.

In one example, in some use cases, implementations and/or scenarios, outputs and/or inputs of an SIMD instruction may have asymmetric uses. For example, execution of such a SIMD instruction may raise one or more constraints for an instruction scheduler. For example, these constraints may be reflected in a resulting register pressure, e.g., as described below.

In some demonstrative aspects, complier 160 may be configured selectively allocate a pair of instructions to be executed as a SIMD instruction, for example, based on a criterion, which may be configured to reduce, e.g., minimize, live intervals corresponding to the pair of instructions, e.g., as described below.

In some demonstrative aspects, the criterion may be configured to provide a technical solution to reduce, e.g., minimize and/or optimize, register usage, e.g., as described below.

In some demonstrative aspects, complier 160 may be configured to provide a technical solution to support reduced, e.g., minimal and/or optimal, usage of registers allocated for execution of a program, for example, for a given instruction scheduling, e.g., based on the source code 112, e.g., as described below.

In some demonstrative aspects, compiler 160 may be configured to combine a pair of instructions, e.g., a pair of similar yet independent instructions, into an SIMD instruction.

In some demonstrative aspects, compiler 160 may be configured to generate a valid instruction scheduling based on the SIMD instruction, e.g., as described below.

In some demonstrative aspects, compiler 160 may be configured to determine whether or not the valid instruction scheduling may result in an invalid register allocation, for example, due to register pressure and/or any other reason, e.g., as described below.

In some demonstrative aspects, compiler 160 may be configured to identify a valid instruction scheduling, which may result in an invalid register allocation, e.g., due to register pressure and/or any other reason.

In some demonstrative aspects, compiler 160 may be configured to attempt finding in the valid instruction scheduling one or more identified SIMD instructions, e.g., SIMD output instructions, having asymmetric uses, for example, based on a determination that the valid instruction scheduling may result in the invalid register allocation, e.g., as described below.

In some demonstrative aspects, compiler 160 may be configured to split an identified SIMD instruction, e.g., each identified SIMD instruction or only some identified SIMD instructions, into two or more instructions, for example, if possible, e.g., as described below.

In some demonstrative aspects, compiler 160 may be configured to generate a new instruction set including the two or more instructions, and to perform instruction scheduling and register allocation on the new instruction set, e.g., as described below.

In some demonstrative aspects, the selective splitting of the identified SIMD instructions into multiple instructions may provide a technical solution to avoid and/or remove asymmetry from the identified SIMD instructions, e.g., as described below.

For example, the removal of asymmetry from the identified SIMD instructions may provide a technical solution to release one or more constraints in the instruction scheduling, e.g., as described below.

In some demonstrative aspects, compiler 160 may be configured to identify, for example, based on source code 112, a first data operation and a second data operation, which may be executable in parallel, e.g., as described below.

In some demonstrative aspects, compiler 160 may be configured to identify the first data operation and the second data operation, which may be executable in parallel, for example, according to a SIMD instruction, e.g., as described below.

In some demonstrative aspects, the SIMD instruction may be configured to be executed, for example, by a single data processing unit (ALU) of a target processor, for example, processor 180, e.g., as described below.

In one example, compiler 200 (FIG. 2) may be configured to identify a first data operation and a second data operation, which may be executed in parallel, for example, according to a SIMD instruction to be executed by a single data processing unit 316 (FIG. 3) of vector processor 300 (FIG. 3).

In some demonstrative aspects, the first data operation and the second data operation may include data operations of a same instruction, e.g., as described below.

In some demonstrative aspects, the first data operation may include a data operation of a first instruction, e.g., as described below.

In some demonstrative aspects, the second data operation may include a data operation of a second instruction, for example, separate from, and/or independent of, the first instruction, e.g., as described below.

In some demonstrative aspects, compiler 160 may be configured to determine a selected compilation scheme to be applied for compiling the first data operation and the second data operation, e.g., as described below.

In some demonstrative aspects, compiler 160 may be configured to determine the selected compilation scheme, for example, from a first compilation scheme and a second compilation scheme, e.g., as described below.

In some demonstrative aspects, compiler 160 may be configured to determine the selected compilation scheme, for example, by selecting the selected compilation scheme from the first compilation scheme and the second compilation scheme, for example, based on a predefined selection criterion, e.g., as described below.

In some demonstrative aspects, the first compilation scheme may include compilation of the first data operation and the second data operation into a SIMD instruction, e.g., as described below.

In some demonstrative aspects, the second compilation scheme may include compilation of the first data operation into a first ALU instruction, and compilation of the second data operation into a second ALU instruction, e.g., as described below.

In some demonstrative aspects, the second ALU instruction may be configured to be executed separately from the first ALU instruction, e.g., as described below.

In some demonstrative aspects, compiler 160 may be configured to generate the target code 115, for example, based on compilation of the first data operation and the second data operation according to the selected compilation scheme, e.g., as described below.

In some demonstrative aspects, compiler 160 may be configured to generate the target code 115 configured, for example, for execution by a Very Long Instruction Word (VLIW) Single Instruction/Multiple Data (SIMD) target processor, e.g., processor 180.

In other aspects, compiler 160 may be configured to generate the target code 115 configured, for example, for execution by any other suitable type of processor.

In some demonstrative aspects, compiler 160 may be configured to generate the target code 115, for example, based on the source code 112 including Open Computing Language (OpenCL) code.

In other aspects, compiler 160 may be configured to generate the target code 115, for example, based on the source code 112 including any other suitable type of code.

In some demonstrative aspects, compiler 160 may be configured to compile the source code 112 into the target code 115, for example, according to a Low Level Virtual Machine (LLVM) based (LLVM-based) compilation scheme.

In other aspects, compiler 160 may be configured to compile the source code 112 into the target code 115 according to any other suitable compilation scheme.

In some demonstrative aspects, the first ALU instruction may be configured to be executed in a first execution cycle, e.g., as described below.

In some demonstrative aspects, the second ALU instruction may be configured to be executed in a second execution cycle, for example, different from the first execution cycle, e.g., as described below.

In some demonstrative aspects, the second compilation scheme may include compilation of the first data operation into the first ALU instruction to be executed, for example, during a first cycle, and compilation of the second data operation into the second ALU instruction to be executed, for example, during a second cycle, which may be different from the first cycle, e.g., as described below.

In some demonstrative aspects, compiler 160 may be configured to identify an ALU to be allocated to execute the second ALU instruction, for example, based on a determination that the ALU is available during the second cycle, e.g., as described below.

In some demonstrative aspects, the first ALU instruction may be configured to be executed by a first ALU of the target processor 180, e.g., as described below.

In some demonstrative aspects, the second ALU instruction may be configured to be executed by a second ALU of the target processor 180, e.g., as described below.

In some demonstrative aspects, the first ALU instruction and the second ALU instruction may be configured to be executed by a same ALU of the target processor 180, e.g., as described below.

In some demonstrative aspects, compiler 160 may be configured to generate target code, e.g., target code 115, which may be configured for execution by the target processor, e.g., processor 180, e.g., as described below.

In some demonstrative aspects, compiler 160 may be configured to determine the selected compilation scheme for compilation of the first and second data operations, for example, according to a predefined selection criterion, which may include, for example, a register-utilization criterion corresponding, for example, to a register utilization of one or more registers of the target processor 180, e.g., as described below.

In some demonstrative aspects, the register-utilization criterion may be based, for example, on the register utilization of the one or more registers of the target processor 180 according to the first compilation scheme, for example, based on utilizing the SIMD instruction to execute the first and second data operations, e.g., as described below.

In some demonstrative aspects, the register-utilization criterion may be configured, for example, such that the selected compilation scheme may include the second compilation scheme, for example, when a first register utilization of the one or more registers of the target processor 180 according to the first compilation scheme is greater than a second register utilization of the one or more registers of the target processor 180 according to the second compilation scheme, e.g., as described below.

In some demonstrative aspects, compiler 160 may be configured to determine that the selected compilation scheme is to include the second compilation scheme, for example, based on a determination that the first register utilization of the one or more registers of the target processor 180 according to the first compilation scheme is greater than the second register utilization of the one or more registers of the target processor 180 according to the second compilation scheme, e.g., as described below.

In some demonstrative aspects, compiler 160 may be configured to determine that the selected compilation scheme is to include the second compilation scheme, for example, based on a determination that the first register utilization of the one or more registers of the target processor 180 according to the first compilation scheme is greater than a predefined register utilization threshold, e.g., as described below.

In other aspects, the register-utilization criterion may include any other additional or alternative criterion relating to the register utilization of the target processor 180.

In some demonstrative aspects, compiler 160 may be configured to determine the selected compilation scheme, for example, according to a predefined selection criterion, which may be based, for example, on a live range of at least one variable corresponding to at least one of the first data operation and/or the second data operation, e.g., as described below.

In some demonstrative aspects, the at least one variable corresponding to the first data operation and/or the second data operation may include, for example, at least one input variable of the first data operation and/or the second data operation, e.g., as described below.

In some demonstrative aspects, the at least one variable corresponding to the first data operation and/or the second data operation may include, for example, at least one output variable resulting from the first data operation and/or the second data operation, e.g., as described below.

In some demonstrative aspects, the predefined selection criterion may be based, for example, on a live range of an input variable of the SIMD instruction, for example, according to the first compilation scheme, e.g., as described below.

In some demonstrative aspects, the predefined selection criterion may be based, for example, on a live range of an output variable resulting from the SIMD instruction, for example, according to the first compilation scheme, e.g., as described below.

In some demonstrative aspects, the predefined selection criterion may be configured, for example, such that the selected compilation scheme is to include the second compilation scheme, for example, when a first live range of the variable according to the first compilation scheme is greater than a second live range of the variable according to the second compilation scheme, e.g., as described below.

In some demonstrative aspects, compiler 160 may be configured to determine that the selected compilation scheme is to include the second compilation scheme, for example, based on a determination that the first live range of the variable according to the first compilation scheme is greater than the second live range of the variable according to the second compilation scheme, e.g., as described below.

In some demonstrative aspects, compiler 160 may be configured to determine that the selected compilation scheme is to include the second compilation scheme, for example, based on a determination that the live range of the variable according to the first compilation scheme is greater than a predefined live range threshold, e.g., as described below.

In some demonstrative aspects, compiler 160 may be configured to determine the selected compilation scheme, for example, according to a predefined selection criterion, which may be based, for example, on a difference between a live range of a first variable and a live range of a second variable, e.g., as described below.

In some demonstrative aspects, the first variable may result from execution of the first data operation by the SIMD instruction, e.g., according to the first compilation scheme, e.g., as described below.

In some demonstrative aspects, the second variable may result from execution of the second data operation by the SIMD instruction, e.g., according to the first compilation scheme, e.g., as described below.

In some demonstrative aspects, the first variable may include an input for execution of the first data operation by the SIMD instruction, e.g., according to the first compilation scheme, e.g., as described below.

In some demonstrative aspects, the second variable may include an input for execution of the second data operation by the SIMD instruction, e.g., according to the first compilation scheme, e.g., as described below.

In some demonstrative aspects, the predefined selection criterion may be based on a register-utilization corresponding to the first compilation scheme, e.g., as described below.

In some demonstrative aspects, the register-utilization corresponding to the first compilation scheme may be based, for example, on a count of cycles that a register is to be occupied by a result of the SIMD instruction, e.g., as described below.

In some demonstrative aspects, the register-utilization corresponding to the first compilation scheme may be based, for example, on a count of cycles between a first cycle, e.g., an initial cycle, in which the result of the SIMD instruction is to be available in the register, and a second cycle, e.g., subsequent to the first cycle, in which the result of the SIMD instruction is to be retrieved from the register, e.g., as described below.

In some demonstrative aspects, the register-utilization corresponding to the first compilation scheme may be based, for example, on a count of cycles that a register is to be occupied by an input variable of the SIMD instruction, e.g., as described below.

In some demonstrative aspects, the register-utilization corresponding to the first compilation scheme may be based, for example, on a count of cycles between a first cycle, e.g., an initial cycle, in which the input variable of the SIMD instruction is to be available in the register, and a second cycle, e.g., subsequent to the first cycle, in which the input variable of the SIMD instruction is to be retrieved from the register, for example for execution of the SIMD instruction, e.g., as described below.

In other aspects, the predefined selection criterion may include any other additional or alternative criterion relating to the live range of the variable resulting from the first data operation and/or the second data operation.

In some demonstrative aspects, the predefined selection criterion may be based, for example, on a latency of the ALU the target processor to execute the SIMD instruction, e.g., as described below.

In other aspects, the predefined selection criterion may include any other additional or alternative criteria, e.g., relating to any other additional or alternative parameter and/or attribute.

In some demonstrative aspects, compiler 160 may be configured to provide a compiled code, e.g., target code 115, for example, based on compilation of the first and second data operations according to the selected compilation scheme, e.g., as described below.

In some demonstrative aspects, compiler 160 may be configured to determine the selected compilation scheme, for example, according to a predefined selection criterion, which may be based, for example, on a live range of at least one output variable to result from execution of the SIMD instruction, for example, according to the first compilation scheme, e.g., as described below.

In some demonstrative aspects, compiler 160 may be configured to process a source code 112 of an executed program.

In one example, source code 112 may include an instruction scheduling, which may be configured, for example, to calculate an expression based on a plurality of variables, for example, including four variables, denoted a, b, c, d, e.g., as follows:

$$( a \cdot b \cdot 3 ) + c \cdot d \qquad ( 1 )$$

For example, the variables a, b, c, d, may be stored in four registers, denoted, R0, R1, R2 and R3, respectively.

For example, compiler 160 may be configured to compile the source code 112 for a processor (SIMD processor) supporting SIMD instructions, e.g., processor 180. For example, the processor may include a first ALU and a second ALU, which may be configured to perform add and multiply instructions, for example, with a latency of 2 cycles.

For example, the SIMD processor may have a memory unit with a latency of 1 cycle for a memory access operation, e.g., a store operation to store a value to the memory unit, or load operation to load a value from the memory unit.

For example, execution of the Expression 1 may be implemented according to the following instruction scheduling, e.g., utilizing a SIMD instruction:

TABLE 1

| | | | |
|---|---|---|---|
| Cycle | ALU1 | ALU2 | Comments |

| | | |
|---|---|---|
| 0 | %0, %1 = | %0 = a · b, %1 = c · d |
| | mul(a, b, c, d) | At First, we assume that it is |
| | | beneficial to use the SIMD mul |
| | | instruction. |
| 1 | | |
| 2 | %2 = mul(%0, 3) | |
| 3 | | |
| 4 | %3 = add(%2, %1) | |

As shown in Table 1, the instructions of the executed program may be performed using only the first ALU (ALU1).

As shown in Table 1, the second ALU (ALU2) may not be required to perform any operations of the executed program.

As shown in Table 1, the execution of the Expression 1 may be performed during 5 cycles.

As Shown in Table 1, the instruction scheduling may include a SIMD instruction to be executed in cycle 0. The SIMD instruction may include a combination of a first data operation, e.g., % 0=a*b, and a second data operation, e.g., % 1=c*d, which may be executed in parallel by the ALU1.

In some demonstrative aspects, compiler 160 may be configured to identify live ranges of variables in the instruction scheduling according to Table 1, e.g., as follows:

TABLE 2

| | Live Range in Cycles |
|---|---|
| Value | [Start, End] (inclusive) |
| %0 | [2, 2] |
| %1 | [2, 4] |
| %2 | [4, 4] |
| %3 | [6, 6] |

As shown in Table 2, the output variable % 1, which may result from the execution of the second data operation in the SIMD instruction, may be live between the cycle 2 and the cycle 4. This live range of the variable % 1 may require occupying a register to store the value of the variable % 1, for example, between the cycle 2 and the cycle 4.

In one example, the requirement to reserve the register for storing the variable % 1 between the cycle 2 and the cycle 4 may result in register pressure.

In some demonstrative aspects, compiler 160 may identify that using the SIMD instruction may result in register pressure.

In some demonstrative aspects, compiler 160 may identify that the SIMD instruction may result in asymmetric use of registers. For example, compiler 160 may identify that the SIMD instruction may result in the output variable % 0, which may be live only in cycle 2, while the output variable % 1 may be required to be maintained live between the cycles 2-4.

In some demonstrative aspects, compiler 160 may be configured to determine that it may be preferable to compile the first data operation, e.g., % 0=a*b, into a first instruction (first ALU instruction), which may be executed, for example, by the first ALU (ALU1), and to compile the second data operation, e.g., % 1=c*d, into a second instruction (second ALU instruction), which may be executed, for example, by the second ALU (ALU2).

In some demonstrative aspects, compiler 160 may be configured to determine that it may be preferable to split the SIMD instruction into the first ALU instruction to be executed by the first ALU, and a second ALU instruction to be executed by the second ALU, e.g., as described below.

In some demonstrative aspects, compiler 160 may be configured generate another instruction scheduling including the first ALU instruction to be executed by the first ALU (ALU1), and the second ALU instruction to be executed by the second ALU (ALU2), e.g., as follows:

TABLE 3

| Cycle | ALU1 | ALU2 | Comments |
|---|---|---|---|
| 0 | %0, _ = mul(a, b, _, _) | | _ is the |
| | | | annotation of |
| 1 | | | unused |
| 2 | %2 = mul(%0, 3) | %1 = mul(c, d, _, _) | _ is the |
| | | | annotation of |
| 3 | | | unused |
| 4 | %3 = add(%2, %1) | | |

As shown in Table 3, the first ALU instruction, e.g., % 0=a*b, may be executed, e.g., by the first ALU, during the cycle 0.

As shown in Table 3, the second ALU instruction, e.g., % 1=c*d, may be executed, e.g., by the second ALU, during the cycle 2.

In some demonstrative aspects, one or more of the variables according to the instruction scheduling of Table 3 may have live ranges, which may be different, for example, from the live ranges of Table 2, e.g., as follows.

TABLE 4

| | Live Range in Cycles |
|---|---|
| Value | [Start, End] (inclusive) |
| %0 | [2, 2] |
| %1 | [4, 4] |
| %2 | [4, 4] |
| %3 | [6, 6] |

As shown in Table 4, the variable % 1 may be live only during the cycle 4, and/or may be free during other cycles.

For example, the variable % 1 may occupy a register only during the cycle 4.

Accordingly, the instruction scheduling of Table 3 may provide a technical solution to reduce utilization of registers, reduce register pressure, and/or reduce a number of used registers.

In some demonstrative aspects, a number of cycles of the executed program according to the instruction set of Table 1 may be equal to a number of cycles of the executed program according to the instruction set of Table 3, e.g., 5 cycles.

In some demonstrative aspects, the executed program according to the instruction set of Table 3 may utilize a reduced number of registers, e.g., compared to the executed program according to the instruction set of Table 1.

Accordingly, the instruction set of Table 3 may be implemented to provide a technical solution to improve performance of the executed program.

In some demonstrative aspects, compiler 160 may be configured to determine the selected compilation scheme, for example, according to a predefined selection criterion, which may be based, for example, on a live range of at least one input variable to be input for execution of the SIMD instruction, for example, according to the first compilation scheme, e.g., as described below.

In one example, source code 112 may include an instruction scheduling, which may be configured to calculate a first expression (data operation) and a second expression (data operation) based on a plurality of variables, for example, including two variables, denoted a, b, e.g., as follows:

$$( 3 - a ) \cdot b \qquad ( 2 )$$

$$4 \cdot a \qquad ( 3 )$$

In some demonstrative aspects, compiler 160 may be configured to load the variable a, for example, from a first memory location (a_add), and/or to load the variable b, for example, from a second memory location (b_add).

In some demonstrative aspects, compiler 160 may be configured to store the variables a, b, in two registers, denoted, R0, and R1, respectively.

For example, compiler 160 may be configured to compile the source code 112 for a processor, e.g., a SIMD processor, which may include a single ALU, e.g., ALU1.

For example, the ALU of the processor may be configured to perform SIMD instructions, e.g., add, multiply and negative instructions, for example, with a latency of 2 cycles.

For example, the SIMD processor may have a memory unit with a latency of 1 cycle for a memory access operation, e.g., a store operation to store a value to the memory unit, or a load operation to load a value from the memory unit.

For example, execution of the Expressions 2 and 3 may be implemented according to the following instruction scheduling, e.g., using a SIMD instruction:

TABLE 5

| | | Load/Store | |
|---|---|---|---|
| Cycle | ALU1 | Unit | Comments |
| 0 | | a = | |
| 1 | %0 = neg(a) | load(a_add) | |
| 2 | | | |
| 3 | %1 = add(%0, 3) | | |
| 4 | | b = | |
| 5 | %2, %3 = | load(b_add) | %2 = (3 − a) · b, |
| | mul(%1, b, 4, a) | | %3 = 4 · a |
| | | | At First, we assume |
| | | | that it is beneficial to |
| | | | use the SIMD mul |
| | | | instruction. |
| 6 | | | |
| 7 | | store(%2, | |
| | | res1_add) | |
| 8 | | store(%3, | |
| | | res2_add) | |

As shown in Table 5, the instructions of the executed program may be performed using the single ALU1.

As shown in Table 5, the execution of the Expression 2 and the Expression 3 may be performed during 9 cycles.

As Shown in Table 5, the instruction scheduling may include a SIMD instruction to be executed in cycle 5.

For example, as shown in Table 5, the SIMD instruction may include a combination of a first instruction, e.g., % 2=% 1*b=(3−a)*b, and a second instruction, e.g., % 3=4*a, which may be executed in parallel by the ALU1.

In some demonstrative aspects, compiler 160 may be configured to identify live ranges of variables in the instruction scheduling, and/or to assign registers to the variables, for example, according to Table 5, e.g., as follows:

TABLE 6

| | Live Range in Cycles | |
|---|---|---|
| | [Start, End] | Assigned |
| Value | (Inclusive) | Register |
| a | [1, 5] | R0 |
| b | [5, 5] | R1 |
| %0 | [3, 3] | R1 |
| %1 | [5, 5] | R2 |
| %2 | [7, 7] | R0 |
| %3 | [7, 8] | R1 |

As shown in Table 6, the register R0 may be occupied between the cycle 1 and the cycle 5, for example, to store the variable a, which may be used as an input for the second instruction in the SIMD instruction.

As shown in Table 6, the register R1 may be occupied during the cycle 5, for example, to store the variable b.

As shown in Table 6, the variable % 1, which may result from the data operation % 1=add (% 0, 3), which may be used as an input for the first instruction in the SIMD instruction, may be live during the cycle 5. For example, this may require occupying a register, e.g. the register R2, to store the value of the variable % 1, for example, during the cycle 5. For example, the variable % 1 may occupy the register R2, for example, as the register R0 and the register R1 may be occupied during the cycle 5.

In one example, the requirement to reserve the register for storing the variable % 1 during the cycle 5 may result in register pressure.

In some demonstrative aspects, compiler 160 may identify that using the SIMD instruction may result in register pressure.

In some demonstrative aspects, compiler 160 may identify that the SIMD instruction results in asymmetric use of registers, e.g., the input variable b is live only in cycle 5, while the input variable a is live between the cycles 1-5.

In some demonstrative aspects, compiler 160 may be configured to determine that it may be preferable to compile the second data operation, e.g., % 3=4*a, into a first multiply instruction to be executed by ALU1, and to compile the first data operation, e.g., % 2=(3−a)*b, into a second multiply instruction to be executed by ALU1, e.g., after the first multiply instruction.

In some demonstrative aspects, compiler 160 may be configured to determine that it may be preferable to split the SIMD instruction into the first multiply instruction and the second multiply instruction.

In some demonstrative aspects, compiler 160 may be configured generate another instruction scheduling including the first multiply instruction to be executed by ALU1, and the second multiply instruction to be executed by ALU1, for example, after the first multiply instruction, e.g., as follows:

TABLE 7

| | | | |
|---|---|---|---|
| 0 | | a = load(a_add) | |
| 1 | %0 = neg(a) | | |
| 2 | %3, _ = mul(4, a, _, _) | | _ is the annotation |
| | | | of unused |
| 3 | %1 = add(%0, 3) | b = load(b_add) | |
| 4 | | store(%3, | |
| | | res2_add) | |
| 5 | %2, _ = mul(%1, b, _, _) | | %2 = (3 − a) · b |
| 6 | | | |
| 7 | | store(%2, | |
| | | res1_add) | |

As shown in Table 7, the first multiply instruction, e.g., % 3=4*a, may be executed by ALU1 during the cycle 2.

As shown in Table 7, the second multiply instruction, e.g., % 2=% 1*b=(3−a)*b, may be executed by ALU1 during the cycle 5.

In some demonstrative aspects, the variables according to the instruction scheduling of Table 7 may have live ranges, which may be different, for example, from the live ranges of Table 6, and/or an assignment of registers to the variables according to the instruction scheduling of Table 7 may be different, for example, from the assignment of registers according to the Table 6, e.g., as follows.

TABLE 8

| | Live Range in | |
|---|---|---|
| | Cycles [Start, | |
| | End] | Assigned |
| Value | (Including) | Register |
| a | [1, 2] | R0 |
| b | [4, 5] | R0 |
| %0 | [3, 3] | R0 |
| %1 | [5, 5] | R1 |
| %2 | [7, 7] | R0 |
| %3 | [4, 4] | R1 |

As shown in Table 8, the variable a may be live between the cycle 1 and the cycle 2, and the variable b may be live between the cycle 4 and the cycle 5. For example, the separate, non-overlapping, live ranges of the variables a and b may be utilized, for example, to assign the variable a and the variable b to occupy a same register, e.g., R0, between the cycle 1 and the cycle 5, for example, instead of occupying two registers, e.g., the registers R0 and R1. Accordingly, the instruction scheduling of Table 7 may be implemented to provide a technical solution to utilize the register R1, e.g., instead of the register R2, for example, to store the variable % during the cycle 5.

Accordingly, the instruction scheduling of Table 7 may provide a technical solution to reduce utilization of registers, reduce register pressure, and/or reduce a number of used registers.

In some demonstrative aspects, a number of cycles of the executed program according to the instruction set of Table 7, e.g., 8 cycles, may be less than a number of cycles of the executed program according to the instruction set of Table 5, e.g., 9 cycles.

In some demonstrative aspects, the executed program according to the instruction set of Table 7 may utilize a reduced number of registers, e.g., 2 registers, for example, compared to the executed program according to the instruction set of Table 5, e.g., 3 registers.

Accordingly, the instruction set of Table 7 may be implemented to provide a technical solution to improve both performance of the executed program as well as register pressure of the executed program.

In one example, an attempt to schedule execution of the Expressions 2 and 3 according to the instruction scheduling of Table 5 may result in an unsuccessful register allocation, e.g., if only two registers are available. One option to address this situation may be to relax the instruction scheduling, e.g., in attempt to reduce the number of live variables sharing the same execution cycles. However, this option may result in degraded performance.

In some demonstrative aspects, execution of the Expressions 2 and 3 according to the register allocation scheme described above, e.g., using the instruction scheduling of Table 7, may provide a technical solution to support successful register allocation, e.g., even if only two registers are available, for example, while avoiding the performance degradation resulting from the instruction scheduling of Table 4.

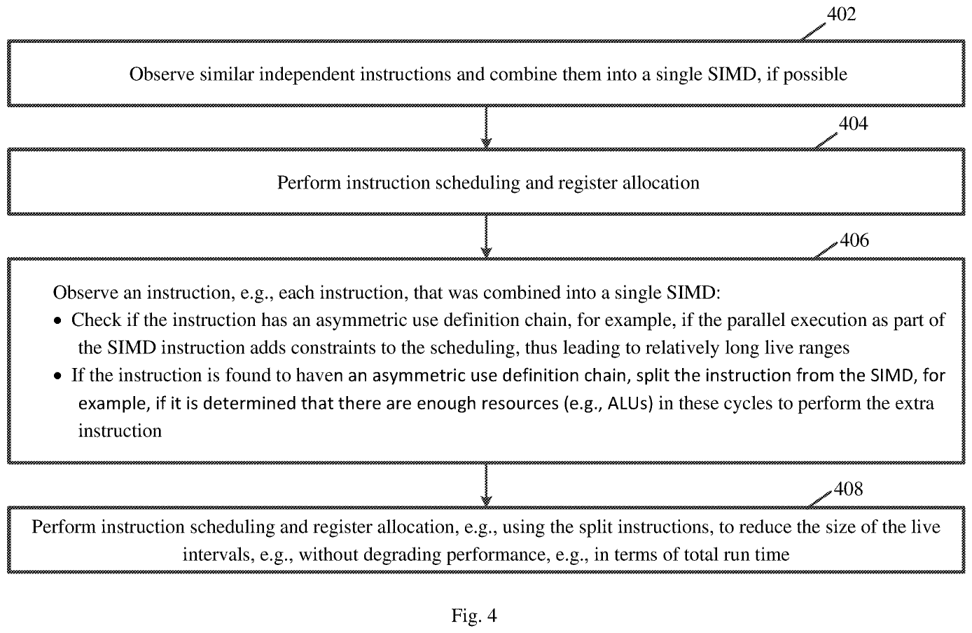

Reference is made to FIG. 4, which schematically illustrates a method of compiling code for a processor. For example, one or more operations of the method of FIG. 4 may be performed by a system, e.g., system 100 (FIG. 1); a device, e.g., device 102 (FIG. 1); a server, e.g., server 170 (FIG. 1); and/or a compiler, e.g., compiler 160 (FIG. 1), and/or compiler 200 (FIG. 2).

In some demonstrative aspects, as indicated at block 402, the method may include processing code to identify one or more pairs of data operations and/or instructions, e.g., similar and independent data operations and/or instructions, which may be potentially combined into an SIMD instruction. For example, compiler 160 (FIG. 1) may identify a pair of similar independent instructions, which may potentially be combined into a single SIMD, e.g., as described above.

In some demonstrative aspects, as indicated at block 404, the method may include performing instruction scheduling and register allocation, for example, using the SIMD instruction. For example, compiler 160 (FIG. 1) may perform instruction scheduling and register allocation using the SIMD instruction, e.g., as described above.

In some demonstrative aspects, as indicated at block 406, the method may include determining whether the SIMD instruction may, e.g., should, be replaced by two separate instructions, e.g., as described below.

In some demonstrative aspects, as indicated at block 406, the method may include observing the instructions, e.g., each of the instructions, which are combined into the SIMD instruction, for example, to determine if the single SIMD has an asymmetric use-definition chain, for example, such that the parallel execution of the pair of instructions adds constraints to the scheduling, which may lead to large live ranges. For example. compiler 160 (FIG. 1) may determine if an instruction in the SIMD instruction leads to a large live range, e.g., as described above.

In some demonstrative aspects, as indicated at block 406, the method may include splitting the SIMD instruction into separate instructions, for example, based on a determination that there are available resources, e.g., ALU resources, to perform the separate instructions. For example, compiler 160 (FIG. 1) may split the SIMD instruction into separate instructions, for example, if it is determined that ALU resources are available to perform the separate instructions, e.g., as described above.

In some demonstrative aspects, as indicated at block 408, the method may include generating an instruction scheduling and register allocation based on the separate instructions, e.g., after splitting the SIMD instruction, for example, to reduce ranges of the live intervals. For example, compiler 160 (FIG. 1) may generate target code 115 (FIG. 1) based on an instruction scheduling and the register allocation, which may be configured to reduce the size of the live range of the variable % 1, e.g., as described above.

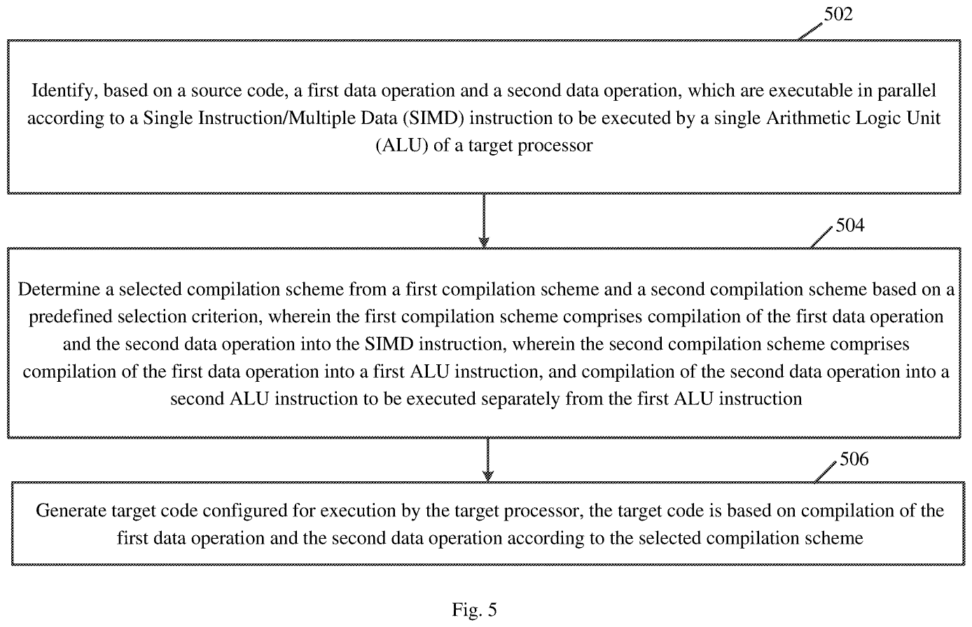

Reference is made to FIG. 5, which schematically illustrates a method of compiling code for a processor. For example, one or more operations of the method of FIG. 5 may be performed by a system, e.g., system 100 (FIG. 1); a device, e.g., device 102 (FIG. 1); a server, e.g., server 170 (FIG. 1); and/or a compiler, e.g., compiler 160 (FIG. 1), and/or compiler 200 (FIG. 2).

In some demonstrative aspects, as indicated at block 502, the method may include identify, e.g., based on a source code, a first data operation and a second data operation, which may be executable in parallel according to a SIMD instruction, e.g., to be executed by a single ALU of a target processor. For example, compiler 160 (FIG. 1) may be configured identify the first and second data operations, for example, based on the source code 112 (FIG. 1), e.g., as descried above.

In some demonstrative aspects, as indicated at block 504, the method may include determining a selected compilation scheme from a first compilation scheme and a second compilation scheme based on a predefined selection criterion. For example, the first compilation scheme may include compilation of the first data operation and the second data operation into the SIMD instruction, and the second compilation scheme may include compilation of the first data operation into a first ALU instruction, and compilation of the second data operation into a second ALU instruction to be executed separately from the first ALU instruction. For example, compiler 160 (FIG. 1) may be configured to identify the selected compilation scheme to compile the first and second data operations, e.g., as described above.

In some demonstrative aspects, as indicated at block 506, the method may include generating target code, which may be configured for execution by the target processor. For example, the target code may be based on compilation of the first data operation and the second data operation according to the selected compilation scheme. For example, compiler 160 (FIG. 1) may be configured to generate the target code 115 (FIG. 1), for example, by compilation of the first and second data operations according to the selected compilation scheme, e.g., as described above.

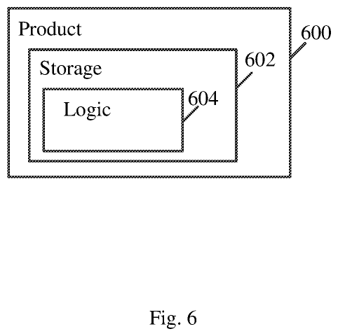

Reference is made to FIG. 6, which schematically illustrates a product of manufacture 600, in accordance with some demonstrative aspects. Product 600 may include one or more tangible computer-readable (“machine-readable”) non-transitory storage media 602, which may include computer-executable instructions, e.g., implemented by logic 604, operable to, when executed by at least one computer processor, enable the at least one computer processor to implement one or more operations at device 102 (FIG. 1), server 170 (FIG. 1), and/or compiler 160 (FIG. 1), to cause device 102 (FIG. 1), server 170 (FIG. 1), and/or compiler 160 (FIG. 1) to perform, trigger and/or implement one or more operations and/or functionalities, and/or to perform, trigger and/or implement one or more operations and/or functionalities described with reference to the FIGS. 1-5, and/or one or more operations described herein. The phrases “non-transitory machine-readable medium” and “computer-readable non-transitory storage media” may be directed to include all computer-readable media, with the sole exception being a transitory propagating signal.

In some demonstrative aspects, product 600 and/or machine-readable storage media 602 may include one or more types of computer-readable storage media capable of storing data, including volatile memory, non-volatile memory, removable or non-removable memory, erasable or non-erasable memory, writeable or re-writeable memory, and the like. For example, machine-readable storage media 602 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 604 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 604 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes a product comprising one or more tangible computer-readable non-transitory storage media comprising computer-executable instructions operable to, when executed by at least one processor, enable the at least one processor to cause a computing device to identify, based on a source code, a first data operation and a second data operation, which are executable in parallel according to a Single Instruction/Multiple Data (SIMD) instruction to be executed by a single Arithmetic Logic Unit (ALU) of a target processor; determine a selected compilation scheme from a first compilation scheme and a second compilation scheme based on a predefined selection criterion, wherein the first compilation scheme comprises compilation of the first data operation and the second data operation into the SIMD instruction, wherein the second compilation scheme comprises compilation of the first data operation into a first ALU instruction, and compilation of the second data operation into a second ALU instruction to be executed separately from the first ALU instruction; and generate target code configured for execution by the target processor, the target code is based on compilation of the first data operation and the second data operation according to the selected compilation scheme.

Example 2 includes the subject matter of Example 1, and optionally, wherein the predefined selection criterion comprises a register-utilization criterion corresponding to a register utilization of one or more registers of the target processor.

Example 3 includes the subject matter of Example 2, and optionally, wherein the register-utilization criterion is based on the register utilization of the one or more registers of the target processor according to the first compilation scheme.

Example 4 includes the subject matter of Example 2 or 3, and optionally, wherein the register-utilization criterion is configured such that the selected compilation scheme is to include the second compilation scheme when a first register utilization of the one or more registers of the target processor according to the first compilation scheme is greater than a second register utilization of the one or more registers of the target processor according to the second compilation scheme.

Example 5 includes the subject matter of any one of Examples 1-4, and optionally, wherein the predefined selection criterion is based on a live range of at least one variable corresponding to at least one of the first data operation or the second data operation.

Example 6 includes the subject matter of Example 5, and optionally, wherein the at least one variable comprises at least one of an input variable of the first data operation or the second data operation, or an output variable resulting from the first data operation or the second data operation.

Example 7 includes the subject matter of Example 5 or 6, and optionally, wherein the predefined selection criterion is based on a live range of an input variable of the SIMD instruction, or an output variable resulting from the SIMD instruction.

Example 8 includes the subject matter of any one of Examples 5-7, and optionally, wherein the predefined selection criterion is configured such that the selected compilation scheme is to include the second compilation scheme when a first live range of the variable according to the first compilation scheme is greater than a second live range of the variable according to the second compilation scheme.

Example 9 includes the subject matter of any one of Examples 1-8, and optionally, wherein the predefined selection criterion is based on a count of cycles between a first cycle in which a result of the SIMD instruction is to be available in a register of the target processor, and a second cycle subsequent to the first cycle, in which the result of the SIMD instruction is to be retrieved from the register of the target processor.

Example 10 includes the subject matter of any one of Examples 1-9, and optionally, wherein the predefined selection criterion is based on a count of cycles between a first cycle in which an input variable of the SIMD instruction is to be available in a register of the target processor, and a second cycle subsequent to the first cycle, in which the input variable of the SIMD instruction is to be retrieved from the register of the target processor.

Example 11 includes the subject matter of any one of Examples 1-10, and optionally, wherein the predefined selection criterion is based on a difference between a live range of a first variable and a live range of a second variable, the first variable resulting from execution of the first data operation by the SIMD instruction, the second variable resulting from execution of the second data operation by the SIMD instruction.

Example 12 includes the subject matter of any one of Examples 1-11, and optionally, wherein the predefined selection criterion is based on a difference between a live range of a first variable and a live range of a second variable, the first variable comprising an input for execution of the first data operation by the SIMD instruction, the second variable comprising an input for execution of the second data operation by the SIMD instruction.

Example 13 includes the subject matter of any one of Examples 1-12, and optionally, wherein the predefined selection criterion is based on a latency of the ALU the target processor to execute the SIMD instruction.

Example 14 includes the subject matter of any one of Examples 1-13, and optionally, wherein the first ALU instruction is configured to be executed in a first execution cycle, and the second ALU instruction is configured to be executed in a second execution cycle different from the first execution cycle.

Example 15 includes the subject matter of any one of Examples 1-14, and optionally, wherein the second compilation scheme comprises compilation of the first data operation into the first ALU instruction to be executed during a first execution cycle, and compilation of the second data operation into the second ALU instruction to be executed during a second cycle, which is different from the first cycle.

Example 16 includes the subject matter of any one of Examples 1-15, and optionally, wherein the first ALU instruction is to be executed by a first ALU, and the second ALU instruction is to be executed by a second ALU.

Example 17 includes the subject matter of any one of Examples 1-15, and optionally, wherein the first ALU instruction and the second ALU instruction are to be executed by a same ALU.

Example 18 includes the subject matter of any one of Examples 1-17, and optionally, wherein the first data operation and the second data operation comprise data operations of a same instruction.

Example 19 includes the subject matter of any one of Examples 1-17, and optionally, wherein the first data operation comprises a data operation of a first instruction, and the second data operation comprises a data operation of a second instruction separate from the first instruction.

Example 20 includes the subject matter of any one of Examples 1-19, and optionally, wherein the source code comprises Open Computing Language (OpenCL) code.

Example 21 includes the subject matter of any one of Examples 1-20, and optionally, wherein the computer-executable instructions, when executed, cause the computing device to compile the source code into the target code according to a Low Level Virtual Machine (LLVM) based (LLVM-based) compilation scheme.

Example 22 includes the subject matter of any one of Examples 1-21, and optionally, wherein the target code is configured for execution by a Very Long Instruction Word (VLIW) Single Instruction/Multiple Data (SIMD) target processor.

Example 23 includes the subject matter of any one of Examples 1-22, and optionally, wherein the target code is configured for execution by a target vector processor.

Example 24 includes a compiler configured to perform any of the described operations of any of Examples 1-23.

Example 25 includes a computing device configured to perform any of the described operations of any of Examples 1-23.

Example 26 includes a computing system comprising at least one memory to store instructions; and at least one processor to retrieve instructions from the memory and execute the instructions to cause the computing system to perform any of the described operations of any of Examples 1-23.

Example 27 includes a computing system comprising a compiler to generate target code according to any of the described operations of any of Examples 1-23, and a processor to execute the target code.

Example 28 comprises an apparatus comprising means for executing any of the described operations of any of Examples 1-23.

Example 29 comprises an apparatus comprising: a memory interface; and processing circuitry configured to: perform any of the described operations of any of Examples 1-23.

Example 30 comprises a method comprising any of the described operations of any of Examples 1-23.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

1.-28. (canceled)

29. A product comprising one or more tangible computer-readable non-transitory storage media comprising computer-executable instructions operable to, when executed by at least one processor, enable the at least one processor to cause a computing device to:
identify, based on a source code, a first data operation and a second data operation, which are executable in parallel according to a Single Instruction/Multiple Data (SIMD) instruction to be executed by a single Arithmetic Logic Unit (ALU) of a target processor;
determine a selected compilation scheme from a first compilation scheme and a second compilation scheme based on a predefined selection criterion, wherein the first compilation scheme comprises compilation of the first data operation and the second data operation into the SIMD instruction, wherein the second compilation scheme comprises compilation of the first data operation into a first ALU instruction, and compilation of the second data operation into a second ALU instruction to be executed separately from the first ALU instruction; and
generate target code configured for execution by the target processor, the target code is based on compilation of the first data operation and the second data operation according to the selected compilation scheme.

30. The product of claim 29, wherein the predefined selection criterion comprises a register-utilization criterion corresponding to a register utilization of one or more registers of the target processor.

31. The product of claim 30, wherein the register-utilization criterion is based on the register utilization of the one or more registers of the target processor according to the first compilation scheme.

32. The product of claim 30, wherein the register-utilization criterion is configured such that the selected compilation scheme is to include the second compilation scheme when a first register utilization of the one or more registers of the target processor according to the first compilation scheme is greater than a second register utilization of the one or more registers of the target processor according to the second compilation scheme.

33. The product of claim 29, wherein the predefined selection criterion is based on a live range of at least one variable corresponding to at least one of the first data operation or the second data operation.

34. The product of claim 33, wherein the at least one variable comprises at least one of an input variable of the first data operation or the second data operation, or an output variable resulting from the first data operation or the second data operation.

35. The product of claim 33, wherein the predefined selection criterion is based on a live range of an input variable of the SIMD instruction, or an output variable resulting from the SIMD instruction.

36. The product of claim 33, wherein the predefined selection criterion is configured such that the selected compilation scheme is to include the second compilation scheme when a first live range of the variable according to the first compilation scheme is greater than a second live range of the variable according to the second compilation scheme.

37. The product of claim 29, wherein the predefined selection criterion is based on a count of cycles between a first cycle in which a result of the SIMD instruction is to be available in a register of the target processor, and a second cycle subsequent to the first cycle, in which the result of the SIMD instruction is to be retrieved from the register of the target processor.

38. The product of claim 29, wherein the predefined selection criterion is based on a count of cycles between a first cycle in which an input variable of the SIMD instruction is to be available in a register of the target processor, and a second cycle subsequent to the first cycle, in which the input variable of the SIMD instruction is to be retrieved from the register of the target processor.

39. The product of claim 29, wherein the predefined selection criterion is based on a difference between a live range of a first variable and a live range of a second variable, the first variable resulting from execution of the first data operation by the SIMD instruction, the second variable resulting from execution of the second data operation by the SIMD instruction.

40. The product of claim 29, wherein the predefined selection criterion is based on a difference between a live range of a first variable and a live range of a second variable, the first variable comprising an input for execution of the first data operation by the SIMD instruction, the second variable comprising an input for execution of the second data operation by the SIMD instruction.

41. The product of claim 29, wherein the predefined selection criterion is based on a latency of the ALU of the target processor to execute the SIMD instruction.

42. The product of claim 29, wherein the first ALU instruction is configured to be executed in a first execution cycle, and the second ALU instruction is configured to be executed in a second execution cycle different from the first execution cycle.

43. The product of claim 29, wherein the second compilation scheme comprises compilation of the first data operation into the first ALU instruction to be executed during a first execution cycle, and compilation of the second data operation into the second ALU instruction to be executed during a second cycle, which is different from the first cycle.

44. The product of claim 29, wherein the first data operation and the second data operation comprise data operations of a same instruction.

45. The product of claim 29, wherein the first data operation comprises a data operation of a first instruction, and the second data operation comprises a data operation of a second instruction separate from the first instruction.

46. The product of claim 29, wherein the source code comprises Open Computing Language (OpenCL) code.

47. The product of claim 29, wherein the computer-executable instructions, when executed, cause the computing device to compile the source code into the target code according to a Low Level Virtual Machine (LLVM) based (LLVM-based) compilation scheme.

48. A computing system comprising:
at least one memory to store instructions; and
at least one processor to retrieve the instructions from the memory and to execute the instructions to cause the computing system to:
identify, based on a source code, a first data operation and a second data operation, which are executable in parallel according to a Single Instruction/Multiple Data (SIMD) instruction to be executed by a single Arithmetic Logic Unit (ALU) of a target processor;
determine a selected compilation scheme from a first compilation scheme and a second compilation scheme based on a predefined selection criterion, wherein the first compilation scheme comprises compilation of the first data operation and the second data operation into the SIMD instruction, wherein the second compilation scheme comprises compilation of the first data operation into a first ALU instruction, and compilation of the second data operation into a second ALU instruction to be executed separately from the first ALU instruction; and
generate target code configured for execution by the target processor, the target code is based on compilation of the first data operation and the second data operation according to the selected compilation scheme.

49. The computing system of claim 48 comprising the target processor.

50. A method comprising:
identifying, based on a source code, a first data operation and a second data operation, which are executable in parallel according to a Single Instruction/Multiple Data (SIMD) instruction to be executed by a single Arithmetic Logic Unit (ALU) of a target processor;
determining a selected compilation scheme from a first compilation scheme and a second compilation scheme based on a predefined selection criterion, wherein the first compilation scheme comprises compilation of the first data operation and the second data operation into the SIMD instruction, wherein the second compilation scheme comprises compilation of the first data operation into a first ALU instruction, and compilation of the second data operation into a second ALU instruction to be executed separately from the first ALU instruction; and
generating target code configured for execution by the target processor, the target code is based on compilation of the first data operation and the second data operation according to the selected compilation scheme.

51. The method of claim 50, wherein the predefined selection criterion is based on a live range of at least one variable corresponding to at least one of the first data operation or the second data operation.
